(19) United States
(12) Patent Application Publication
(10) Pub. No.: US 2004/0128317 A1
(43) Pub. Date: Jul. 1, 2004

(54) Methods and apparatuses for viewing, browsing, navigating and bookmarking videos and displaying images

(76) Inventors: Sanghoon Sull, Seoul (KR); Seong Soo Chun, Songnam City (KR); Ja-Cheon Yoon, Seoul (KR); Jung-Rim Kim, Seoul (KR); Hyeokman Kim, Seoul (KR)

Correspondence Address: Gerald E. Linden, 12925 La Rochelle Cr., Palm Beach Gardens, FL, 33410, US

(21) Appl. No.: 10/365,576

(22) Filed: Feb. 12, 2003

Related U.S. Application Data
(63) Continuation-in-part of application No. 09/911,293, filed on Jul. 23, 2001.
(63) Continuation-in-part of application No. PCT/US01/23631, filed on Jul. 23, 2001.
(60) Provisional application No. 60/221,394, filed on Jul. 24, 2000.
(60) Provisional application No. 60/221,843, filed on Jul. 28, 2000.
(60) Provisional application No. 60/222,373, filed on Jul. 31, 2000.
(60) Provisional application No. 60/271,908, filed on Feb. 27, 2001.
(60) Provisional application No. 60/291,728, filed on May 17, 2001.
(60) Provisional application No. 60/221,394, filed on Jul. 24, 2000.
(60) Provisional application No. 60/221,843, filed on Jul. 28, 2000.
(60) Provisional application No. 60/222,373, filed on Jul. 31, 2000.
(60) Provisional application No. 60/271,908, filed on Feb. 27, 2001.
(60) Provisional application No. 60/291,728, filed on May 17, 2001.
(60) Provisional application No. 60/359,566, filed on Feb. 25, 2002.
(60) Provisional application No. 60/434,173, filed on Dec. 17, 2002.
(60) Provisional application No. 60/359,564, filed on Feb. 25, 2002.

(51) Int. Cl. G06F 7/00

(52) U.S. Cl. 707/104.1

(57) ABSTRACT

Locally generating content characteristics for a plurality of video programs which have been recorded and displaying the content characteristics of the plurality of video programs, thereby enabling users to easily select the video of interest as well as a segment of interest within the selected video. The content characteristic can be generated according to user preference, and will typically comprise at least one key frame image or a plurality of images displayed in the form of an animated image or a video stream shown in a small size.

### CROSS-REFERENCE TO RELATED APPLICATIONS

This is a continuation-in-part of U.S. patent application Ser. No. 09/911,293 filed Jul. 23, 2001 (published as US2002/0069218A1 on Jun. 6, 2002), which is a non-provisional of:

provisional application No. 60/221,394 filed Jul. 24, 2000;

provisional application No. 60/221,843 filed Jul. 28, 2000;

provisional application No. 60/222,373 filed Jul. 31, 2000;

provisional application No. 60/271,908 filed Feb. 27, 2001; and

provisional application No. 60/291,728 filed May 17, 2001.

This application is a continuation-in-part of PCT Patent Application No. PCT/US01/23631 filed Jul. 23, 2001 (Published as WO 02/08948, 31 Jan. 2002), which claims priority of the five provisional applications listed above.

This is a continuation-in-part of U.S. Provisional Application No. 60/359,566 filed Feb. 25, 2002.

This is a continuation-in-part of U.S. Provisional Application No. 60/434,173 filed Dec. 17, 2002.

This is a continuation-in-part of U.S. Provisional Application No. U.S. S No. 60/359,564 filed Feb. 25, 2002.

This is a continuation-in-part of U.S. patent application Ser. No. ______ (docket Viv-P1), by Sanghoon Sull, Sungjoo Suh, Jung Rim Kim, Seong Soo Chun, entitled RAPID PRODUCTION OF REDUCED-SIZE IMAGES FROM COMPRESSED VIDEO STREAMS, filed Feb. 10, 2003.

### TECHNICAL FIELD OF THE INVENTION

The invention relates to the processing of video signals, and more particularly to techniques for viewing, browsing, navigating and bookmarking videos and displaying images.

### BACKGROUND OF THE INVENTION

Generally, a video program (or simply “video”) comprises several (usually at least hundreds, often many thousands of) individual images, or frames. A thematically related sequence of contiguous images is usually termed a “segment”. A sequence of images, taken from a single point of view (or vantage point, or camera angle), is usually termed a “shot”. A segment of a video may comprise a plurality of shots. The video may also contain audio and text information. The present invention is primarily concerned with the video content.

It is generally important, for purposes of indexing and/or navigating through a video, to detect the various shots within a video—i.e., the end of one shot, and the beginning of a subsequent shot. This process is usually termed “shot detection” (or “cut detection”). Various techniques are known for shot detection. Sometimes the transition between two consecutive shots is quite sharp, and abrupt. A sharp transition (cut) is simply a concatenation of two consecutive shots. The transition between subsequent shots can also be gradual, with the transition being somewhat blurred, with frames from both shots contributing to the video content during the transition.

Visual rhythm is a known technique whereby a video is sub-sampled, frame-by-frame, to produce a single image which contains (and conveys) information about the visual content of the video. It is useful, inter alia, for shot detection. A visual rhythm image is typically obtained by sampling pixels lying along a sampling path, such as a diagonal line traversing each frame. A line image is produced for the frame, and the resulting line images are stacked, one next to the other, typically from left-to-right. In this manner, the visual rhythm image contains patterns or visual features that allow the viewer/operator to distinguish and classify many different types of video effects, (edits and otherwise), including: cuts, wipes, dissolves, fades, camera motions, object motions, flashlights, zooms, etc. The different video effects manifest themselves as different patterns on the visual rhythm image. Shot boundaries and transitions between shots can be detected by observing the visual rhythm image which is produced from a video. Visual rhythm is discussed in an article entitled “An efficient graphical shot verifier incorporating visual rhythm”, by H. Kim, J. Lee and S. M. Song, Proceedings of IEEE International Conference on Multimedia Computing and Systems, pp. 827-834, June, 1999.

Video programs are typically embodied as data files. These data files can be stored on mass data storage devices such as hard disk drives (HDDs). It should be understood, that as used herein, the hard disk drive (HDD) is merely exemplary of any suitable mass data storage device. In the future, it is quite conceivable that solid state or other technology mass storage devices will become available. The data files can be transmitted (distributed) over various communications media (networks), such as satellite, cable, Internet, etc. Various techniques are known for compressing video data files prior to storing or transmitting them. When a video is in transit, or is being read from a mass storage device, it is often referred to as a video “stream”.

Video compression is a technique for encoding a video “stream” or “bitstream” into a different encoded form (usually a more compact form) than its original representation. A video “stream” is an electronic representation of a moving picture image. One of the more significant and best known video compression standards for encoding streaming video is the MPEG-2 standard. The MPEG-2 video compression standard achieves high data compression ratios by producing information for a full frame video image only every so often. These full-frame images, or “intra-coded” frames (pictures) are referred to as “I-frames”—each 1-frame containing a complete description of a single video frame (image or picture) independent of any other frame. These “I-frame” images act as “anchor frames” (sometimes referred to as “reference frames”) that serve as reference images within an MPEG-2 stream. Between the I-frames, delta-coding, motion compensation, and interpolative/predictive techniques are used to produce intervening frames. “Inter-coded” B-frames (bidirectionally-coded frames) and P-frames (predictive-coded frames) are examples of such “in-between” frames encoded between the I-frames, storing only information about differences between the intervening frames they represent with respect to the I-frames (reference frames).

A video cassette recorder (VCR) stores video programs as analog signals, on magnetic tape. Cable and satellite decoders receive and demodulate signals from the respective cable and satellite communications media. A modem receives and demodulates signals from a telephone line, or the like.

Set Top Boxes (STBs) incorporate the functions of receiving and demodulating/decoding signals, and providing an output to a display device, which usually is a standard television (TV) or a high definition television (HDTV) set. A digital video recorder is (DVR) is usually a STB which has a HDD associated therewith for recording (storing) video programs. A DVR is essentially a digital VCR with and is operated by personal video recording (PVR) software, which enables the viewer to pause, fast forward, and manage various other functions and special applications. A user interacts with the STB or DVR via an input device, such as a wireless, typically infrared (IR), remote control having a number of buttons for selecting functions and/or adjusting operating parameters of the STB or DVR.

Among the most useful and important features of modern STBs are video browsing, visual bookmark capability, and picture-in-picture (PIP) capability. These features typically employ reduced-size versions of video frames, which are displayed in one or more small areas of a display screen. For example, a plurality of reduced-size “thumbnail images” or “thumbnails” may be displayed as a set of index “tiles” on the display screen as a part of a video browsing function. These thumbnail images may be derived from stored video streams (e.g., stored in memory or on a HDD), video streams being recorded, video streams being transmitted/broadcast, or obtained “on-the-fly” in real time from a video stream being displayed.

An Electronic Programming Guide (EPG) is an electronic listing of television (TV) channels, with program information, including the time that the program is aired. An Interactive Program Guide (IPG) is essentially an EPG with advanced features such as program searching by genre or title and one click VCR (or DVR) recording. Much TV programming is broadcast (transmitted) over a communication network such as a satellite channel, the Internet or a cable system, from a broadcaster, such as a satellite operator, server, or multiple system operator (MSO). The EPG (or IPG) may be transmitted along with the video programming, in another portion of the bandwidth, or by a special service provider associated with the broadcaster. Since the EPG provides a time schedule of the programs to be broadcast, it can readily be utilized for scheduled recording in TV set-top box (STB) with digital video recording capability. The EPG facilitates a user's efforts to search for TV programs of interest. However, an EPG's two-dimensional presentation (channels vs. time slots) can become cumbersome as terrestrial, cable, and satellite systems send out thousands of programs through hundreds of channels. Navigation through a large table of rows and columns in order to search for desired programs can be quite frustrating.

FIG. 1A illustrates, generally, a distribution network for providing (broadcasting) video programs to users. A broadcaster 102 broadcasts the video programs, typically at prescribed times, via a communications medium 104 such as satellite, terrestrial link or cable, to a plurality of users. Each user will typically have a STB 106 for receiving the broadcasts. A special service provider 108 may also receive the broadcasts and/or related information from the broadcaster 102, and may provide information related to the video programming, such as an EPG, to the user's STB 106, via a link 110. Additional information, such as an electronic programming guide (EPG), can also be delivered directly from the broadcaster 102, through communications medium 104, to the STB 106.

FIG. 1B illustrates, generically, a STB 120 having a HDD 122 and capable of functioning as a DVR. A tuner 124 receives a plurality of video programs which are simultaneously broadcast over the communication's medium (e.g., satellite). A demultiplexer (DEMUX) 126 re-assembles packets of the video signal (such as which was MPEG-2 encoded-multiplexed). A decoder 128 decodes the assembled, encoded (e.g., MPEG-2) signal. A CPU with RAM 130 (shown in this figure as one block) controls the storing and accessing video signals on the HDD 122. A user controller 132 is provided, such as a TV remote control. A display buffer 142 temporally stores the decoded video frame to be viewed on a display device 134, such as a TV monitor.

Glossary

Unless otherwise noted, or as may be evident from the context of their usage, any terms, abbreviations, acronyms or scientific symbols and notations used herein are to be given their ordinary meaning in the technical discipline to which the invention most nearly pertains. The following terms, abbreviations and acronyms may be used in the description contained herein:

ATSC Advanced Television Systems Committee

DB database

CPU central processing unit (microprocessor)

DVB Digital Video Broadcasting Project

DVR Digital Video Recorder

EIT event information table

EPG Electronic Program(ming) Guide

GUI Graphical User Interface

HDD Hard Disc Drive

HDTV High Definition Television

key frame also key frame, key frame, key frame image. a single, still image derived from a video program comprising a plurality of images.

MPEG Motion Pictures Expert Group, a standards organization dedicated primarily to digital motion picture encoding

MPEG-2 an encoding standard for digital television (officially designated as ISO/IEC 13818, in 9 parts)

MPEG-4 an encoding standard for multimedia applications (officially designated as ISO/IEC 14496, in 6 parts)

OSD On Screen Display

PCR program clock reference

PDA personal digital assistant

PIP picture-in-picture

PSIP program and system information protocol

PTS presentation time stamp

RAM random access memory

ReplayTV (www.replaytv.com)

SDTV Standard Definition Television

STB set top box

Tivo (www.tivo.com)

TV Television

URI Universal Resource Identifier

URL Universal Resource Locator

VCR video cassette recorder

Visual Rhythm (also VR) The visual rhythm of a video is a single image, that is, a two-dimensional abstraction of the entire three-dimensional content of the video constructed by sampling certain group of pixels of each image sequence and temporally accumulating the samples along time.

### BRIEF DESCRIPTION (SUMMARY) OF THE INVENTION

It is therefore a general object of the invention to provide improved techniques for viewing, browsing, navigating and bookmarking videos and displaying images.

According to the invention, a method is provided for accessing video programs that have been recorded, comprising displaying a list of the recorded video programs, locally generating content characteristics for a plurality of video programs which have been recorded, and displaying the content characteristics of the plurality of video programs, thereby enabling users to easily select the video of interest as well as a segment of interest within the selected video. The content characteristic can be generated according to user preference, and will typically comprise at least one key frame image or a plurality of images displayed in the form of an animated image or a video stream shown in a small size.

According to a feature of the invention, the content characteristics for a plurality of stored videos programs are displayed in fields, and a user can select a video program of interest by scrolling through the fields to select a video program of interest. A text field comprises at least one of title, recording time, duration and channel of the video, and an image field comprises at least one of still image, a plurality of images displayed in the form of an animated image or a video stream shown in a small size.

According to an aspect of the invention, a number of features are provided for allowing a user to fast access a video segment of a stored video. A plurality of key frame images are extracted for the stored video, and the key frame images for at least a portion of the video stream are displayed. The key frame images may be extracted at positions in the stored video corresponding to uniformly spaced time intervals. The key frame images may be displayed in sequential order based on time, starting from a top left corner of the display to the bottom right corner of the display. The user moves a cursor to select a key frame of interest. If the cursor remains idle on the key frame image of interest for a predetermined amount of time, the video segment associated with the key frame image of interest is played as a small image within the window of the key frame of interest. The user may fast forward or fast rewind the video segment which is displayed within the window of the highlighted cursor and, when the user finds the exact location of interest for playback within the small image, the user can make an input to indicate that the exact position for playback has been found. The user interface can then be hidden, and the video which was shown in small size is then shown in full size.

According to the invention, a method of browsing video programs in broadcast streams comprises selecting a first broadcast stream and displaying the broadcast stream on display device, and browsing other channels, generating temporally sampled reduced-size images from the associated broadcast streams, and displaying the reduced-size images on the display device. This can be done with either one or two tuners. Frequently-tuned channels can be browsed based on information about a user's channel preferences, such as by displaying favorite channels in the order of user's channel preference.

According to an aspect of the invention an electronic program guide (EPG) is displayed by prioritizing a user's favorite channels, displaying the user's favorite channels in the order of preference in the EPG. The list of favorite channels may be specified by the user, or they may be determined automatically by analyzing user history data and tracking the user's channels of interest.

According to an aspect of the invention, a method is provided for scheduled recording based on an electronic program guide (EPG). The EPG is stored, a program is selected for recording, and recording is scheduled to start a predetermined time before the scheduled start time and to end a predetermined time after the scheduled end time. The method includes checking for updated EPG information of the actual broadcast times a predetermined time before and a predetermined time after recording the program, and accessing the exact start and end positions for the recorded program based on the actual broadcast times. Program start scenes are gathered and stored them in a database. Features are extracted from the program start scenes, and the EPG may be updated by matching between features in the database and those from the live input signal.

According to a feature of the invention, a method of displaying a reduced-size image corresponding to a larger, original image, comprises reducing the original image to a size which is larger than the size of a display area; and cropping the reduced-size image to fit within the display area.

According to the invention, techniques are described for recording an event which is a segment of a live broadcast stream. The techniques are based on partitioning a hard drive to have a time shifting area and a recording area. The time shifting area may be dynamically allocated from empty space on the hard drive.

Apparatus is disclosed for effecting the methods.

A feature of the invention is that a partial/low-cost video decoder may be used to generate reduced-size images (thumbnails) or frames, whereas other STBs typically use a full video decoder chip. Thus, other STBs generate thumbnails by capturing the fully decoded image and reducing the size. The problem is that the full decoder cannot be used to play the video while generating thumbnails. To solve the problem, other STBs pre-generate thumbnails and stores them, and thus they need to manage the image files. Also, the thumbnails images generated from the output of the full decoder are sometime distorted. According to the invention, the generation of (reduced) I frames without also decoding P and B frames is enough for a variety of purposes such as video browsing.

As used herein, a single “full decoder” parses only one video stream (although some of the current MPEG-2 decoder chips can parse multiple video streams). A full decoder implemented in either hardware or software fully decodes the I-,P-,B-frames in compressed video such as MPEG-2, and is thus computationally expensive. The “low cost” or “partial” decoder referred to in the embodiments of the present invention suitably only partially decodes the desired temporal position of video stream by utilizing only a few coefficients in compressed domain without fully decompressing the video stream. The low cost decoder could also be a decoder which partially decodes only an I-frame near the desired position of video stream by utilizing only a few coefficients in compressed domain which is enough for the purpose of browsing and summary. An advantage of using the low cost decoder is that it is computationally inexpensive, and can be implemented in low-cost.

A fuller description of a low cost (partial) decoder suitable for use in the various embodiments of the present invention may be found in the aforementioned U.S. Provisional Application No. U.S. S No. 60/359,564 as well as in the aforementioned U.S. patent application Ser. No. ______ (docket Viv-P1).

In various ones of the embodiments set forth herein, an STB has either (i) two full decoder chips, or (ii) one full decoder and one partial decoder. In other embodiments, the STB has either a partial decoder and a full decoder, or simply a full decoder and the CPU handling the task of partial decoding.

Other objects, features and advantages of the invention will become apparent in light of the following description thereof.

### BRIEF DESCRIPTION OF THE DRAWINGS

Reference will be made in detail to preferred embodiments of the invention, examples of which are illustrated in the accompanying drawings (figures). The drawings are intended to be illustrative, not limiting, and it should be understood that it is not intended to limit the invention to the illustrated embodiments.

Elements of the figures are typically numbered as follows. The most significant digits (hundreds) of the reference number correspond to the figure number. For example, elements of FIG. 1 are typically numbered in the range of 100-199, and elements of FIG. 2 are typically numbered in the range of 200-299, and so forth. Similar elements throughout the figures may be referred to by similar reference numerals. For example, the element 199 in FIG. 1 may be similar (and, in some cases identical) to the element 299 in FIG. 2. Throughout the figures, each of a plurality of similar elements 199 may be referred to individually as 199a, 199b, 199c, etc. Such relationships, if any, between similar elements in the same or different figures will become apparent throughout the specification, including, if applicable, in the claims and abstract.

Light shading (cross-hatching) may be employed to help the reader distinguish between different ones of similar elements (e.g., adjacent pixels), or different portions of blocks.

The structure, operation, and advantages of the present preferred embodiment of the invention will become further apparent upon consideration of the following description taken in conjunction with the accompanying figures.

FIG. 1A is a schematic illustration of a distribution network for video programs, according to the prior art.

FIG. 1B is a block diagram of a set top box (STB) for receiving, storing and viewing video programs, according to the prior art.

FIG. 2A is an illustration of a display image, according to the invention.

FIG. 2B is an illustration of a display image, according to the invention.

FIG. 2C is an illustration of a display image, according to the invention.

FIG. 3 is a block diagram of a digital video recorder (DVR), according to the invention.

FIG. 4A is a block diagram of a DVR, according to the invention.

FIG. 4B is a block diagram of a DVR, according to the invention.

FIG. 5A is an illustration of a display image, according to the invention.

FIG. 5B is an illustration of a display image, according to the invention.

FIG. 6 is an illustration of a display image, according to an embodiment of the invention

FIG. 7 is a block diagram of a (DVR), according to the invention.

FIG. 8A is a block diagram of a DVR, according to the invention.

FIG. 8B is a block diagram of a DVR, according to the invention.

FIG. 8C is a block diagram of a DVR, according to the invention.

FIG. 9 is an illustration of a display, according to the invention.

FIG. 10 is an illustration of a display image, according to the invention.

FIG. 11A is an illustration of static storage area allocation, according to the invention.

FIG. 11B is an illustration of dynamic storage area allocation, according to the invention.

FIG. 12A is a block diagram of a channel browser according to the invention.

FIG. 12B is a block diagram of a channel browser according to the invention.

FIG. 12C is a block diagram of a channel browser according to the invention.

FIG. 13 is a illustration of sorted channel data, according to the invention.

FIG. 14A is an illustration of a display image, according to the invention.

FIG. 14B is an illustration of a display image, according to the invention.

FIG. 15A is an illustration of a conventional EPG display.

FIG. 15B is an illustration of analyzing user history data, according to the invention.

FIG. 15C is an illustration of an EPG display, according to the invention.

FIG. 16 is a block diagram of a set top box, according to the invention.

FIG. 17A is an illustration of an embodiment of the present invention showing a program list using EPG.

FIG. 17B is an illustration of an embodiment of the present invention showing a recording schedule list.

FIG. 17C is an illustration of an embodiment of the present invention showing a list of the recorded programs.

FIG. 17D is an illustration of an embodiment of the present invention showing a time offset table of recorded program.

FIG. 17E is an illustration of an embodiment of the present invention showing a program list using the updated EPG.

FIG. 17F is an illustration of an embodiment of the present invention showing a time offset table of recorded program using the updated EPG.

FIG. 18 is a block diagram of a pattern matching system, according to the invention.

FIGS. 19(A)-(D) are diagrams illustrating some examples of sampling paths drawn over a video frame, for generating visual rhythms, according to the invention.

FIG. 20 is a visual rhythm image.

FIG. 21 is a diagram showing the result of matching between live broadcast video shots and stored video shots, according to the invention.

FIG. 22A is an illustration of an original size image.

FIG. 22B is an illustration of a reduced-size image, according to the prior art.

FIG. 22C is an illustration of a reduced-size image, according to the invention.

FIG. 23 is a diagram showing a portion of a visual rhythm image, according to the prior art.

### DETAILED DESCRIPTION OF THE INVENTION

The following description includes preferred, as well as alternate embodiments of the invention. The description is divided into sections, with section headings which are provided merely as a convenience to the reader. It is specifically intended that the section headings not be considered to be limiting, in any way. The section headings are, as follows:

I. Displaying A List Of Multiple Recorded Videos

II. Fast Navigation Of Time-Shifted Video

III. Video Bookmarking

IV. Fast Accessing Of Video Through Dynamic Displaying Of A List Of Key frames

V. Backward Recording using Time Shifting Area

VI. Channel Browsing using User Preference

VII. The EPG Display using User Preference and User History

VIII. Method and Apparatus of Enhanced Video Playback using Updated EPG

IX. Automatic EPG Updating System using video analysis

X. Efficient method for displaying images or video in a display device

I. Displaying a List of Multiple Recorded Videos

As mentioned above, a DVR is capable of recording (storing) large number of video programs on its associated hard disk (HDD). According to this aspect of the invention, a technique is provided for accessing the programs that have been recorded on the hard disk.

Conventional DVRs provide this feature by listing the titles of all the programs that have been recorded on the hard disk along with the date and time the respective program has been recorded by utilizing the electronic programming guide (EPG). However, it is difficult for users to quickly browse a list of recorded programs based only on the displayed titles along with date and time of the respective program. Although text messages related to each of the recorded programs can be displayed once requested by the user through the EPG, these messages typically either do not convey much information or take up too much of the display device if described in too great detail. Thus, it would be advantageous to offer additional information of the content characteristic related to each of the recorded programs and displayed in an efficient manner.

For example, the content characteristics of the recorded program could be a key frame image transmitted through network or multiplexed in the transmitted broadcast video stream. However to select and deliver an additional content related to the large number of broadcast programs requires extensive human operators' work and additional bandwidth for transmission. Therefore, it would be advantageous if the content characteristic related to each of the recorded programs could be generated within the DVR itself. Further, it would be desirable if the content characteristic of each recorded program would be generated according to the user preference of each DVR user, as opposed to the content characteristic that is selected and delivered by service/content provider. Another advantage of generating the content characteristic of each of the recorded programs on a DVR will accrue when a user records their own video material whose content characteristic is not provided by providers.

In case, the content characteristic of the recorded program is a multiple of key frame images either transmitted through network or multiplexed in the transmitted broadcast video stream or generated within the DVR itself, an efficient way for displaying a multiple of key frame image for each recorded program is needed.

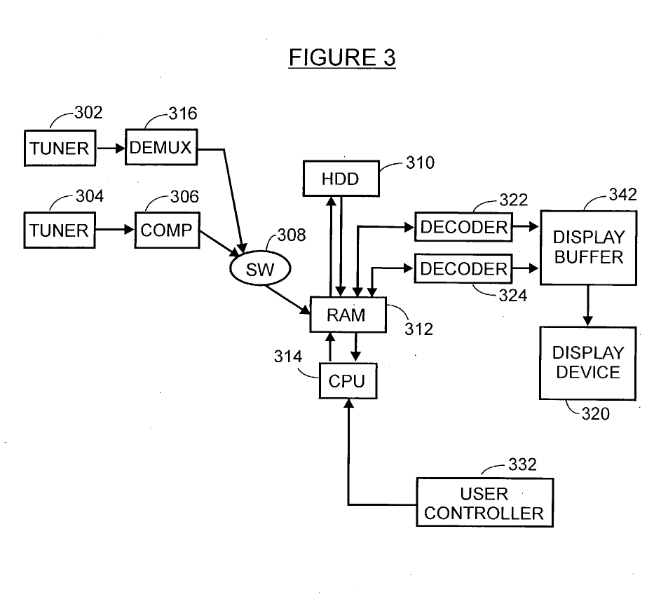

U.S. Pat. No. 6,222,532 (“Ceccarelli”) discloses a method and device for navigating through video matter by means of displaying a plurality of key frames in parallel. (see also U.S. Pat. No. 6,340,971 (“Janse”). Generally, as shown in FIG. 3 therein, a screen presents 20 key frames which are related to a selected portion of an overall presentation (video program). The selected portion is represented on the display by a visually distinct segment of an overall (progress) bar. Using a remote control, the user may move a rectangular control cursor over the displayed key frames, and a particular key frame (144) may be highlighted and selected. The user may also access the progress bar to select other portions of the overall video program. A plurality of control buttons for functions are also displayed. Functions are initiated by first selecting a particular key frame, and subsequently one of the control buttons, such as “view program” which will initiate viewing at the cursor-accessed key frame. However, Ceccarelli only provides a multiple of key frame images for a single video for allowing selective accessing of displayed key frames for navigation, and is not appropriate for selecting the recorded program of interest for playback.

According to the invention, a technique is provided for “locally” generating the content characteristic of multiple video streams (programs) recorded on consumer devices such as a DVR, and displaying of the content characteristics of multiple video streams enabling users to easily select the video of interest as well as the segment of interest within the selected video.

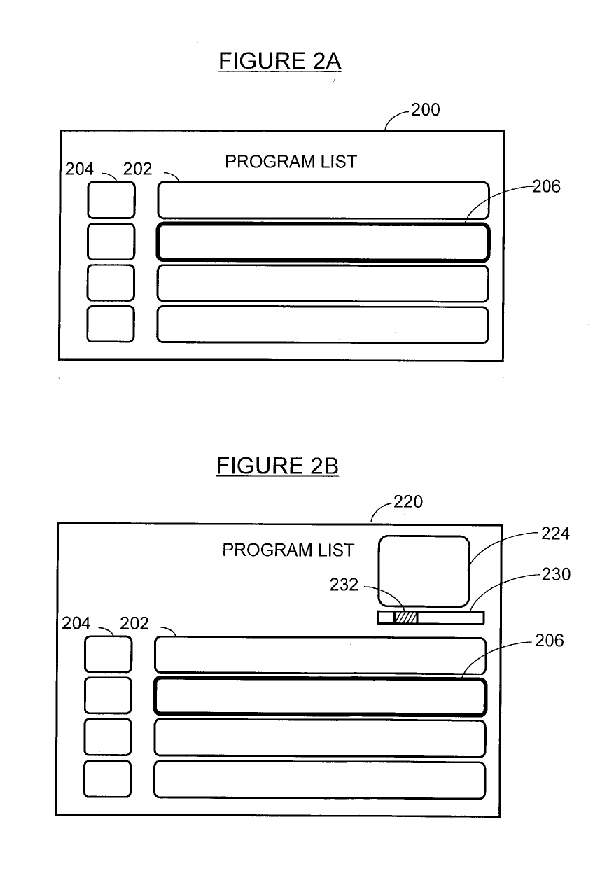

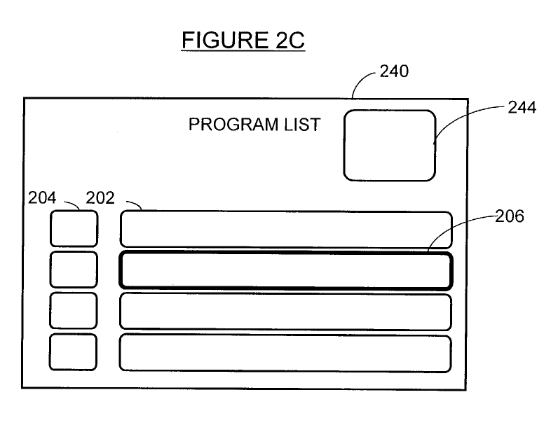

FIG. 2A illustrates a display screen image 200, according to an embodiment of the invention. In this example, a number (4) of video programs have been recorded, and stored in the DVR. A program list (PROGRAM LIST) is displayed.

For each of a plurality of recorded programs, information such as the title, recording time, duration and channel of the program are displayed in a field 202. Along with the title (e.g.,) of the recorded program, a content characteristic for each recorded program is displayed in a field 204. The content characteristic of each recorded program may be a (reduced-size) still image (thumbnail), a plurality of images displayed in the form of an animated image or a video stream shown in a small size. Therefore, for each of the plurality of recorded programs, the field 202 displays textual data relating to the program, and the field 204 displays content characteristics relating to the program. For each program, the image/video field 204 is paired with the corresponding text field 202. In the figure, the field 204 is displayed adjacent, on the same horizontal level as the field 202 so that the nexus (association) of the two fields is readily apparent to the user. Using an input device (see 132), a user selects a program to view by moving a cursor indicator 206 (shown as a visually-distinctive, heavy line surrounding a field 202) upwards or downwards, in the program list. This can be done by scrolling though the image fields 204, or the text fields 202. Therefore, a user can easily select the program to play by viewing the content characteristic of each recorded program.

When a still image is utilized as the content characteristic of each recorded program, the still images can be generated from the recorded video stream through an appropriate derivation algorithm. For example, the representative image of each recorded program can be a reduced picture extracted from a start of the first video shot, or simply the first intracoded picture from five seconds from the start of the video stream. The extracted reduced image can then be verified for the appropriateness as the content characteristics of each recorded program and, if not, a new reduced image is extracted. For example, a simple algorithm can detect whether the extracted image is either black or blank or whether it is an image in between the occurrence of a fade-in or fade-out and if so a new reduced image is extracted. Furthermore, the still image can be one of the temporal/byte positions marked and stored by a user as a video bookmark.

“Video bookmark” is a functionality which allows the user to access a content at a later time from the position of the multimedia file a user has specified. Therefore the video bookmark stores the relative time or byte position from the beginning of a multimedia content along with the file name, Universal Resource Locator (URL), or the Universal Resource Identifier (URI). Additionally the video bookmark can also store an image extracted from the video bookmark position marked by the user such that the user can easily reach the segment of interest through the title of the video bookmark displayed along with the stored image of the corresponding location. Whenever a user decides to video bookmark a specific position in the recorded program, the corresponding stored image of the video bookmark position is therefore of great inherent interest to the user and can well represent the recorded program according to individual user's preference. Therefore, the representative still image (e.g., 204) of each recorded program could be obtained from any of the stored images of the several video bookmarks marked by a user for the corresponding recorded program or generated from the relative time or byte position stored in the bookmark, if any exists.

In case a plurality of images displayed in the form of an animated image is utilized as the content characteristic (204) of each recorded program, the plurality of images can be generated from the recorded video stream through any suitable derivation algorithm, or generated or retrieved from images marked and stored by a user as a video bookmark. The cursor 206 is moved upwards or downwards for the selection of the recorded video. The image is displayed in the form of animated image by sequentially superimposing one image after another in an arbitrary time interval for a recorded program that is highlighted through the cursor 206. Therefore only one of the images in 204 is displayed in the form of animated image for the video pointed by the cursor 206 and the other images are displayed as still images. Furthermore, the image highlighted through the cursor 206 can be displayed in the form of still image for a specified amount of time and if the highlighted cursor remains still for a specified amount of time the animated image can be displayed for the video directed by the highlighted cursor. Note that the animated image described herein might be replaced by a video stream.

In the descriptions set forth herein, various embodiments of the invention are described largely in the context of a familiar user interface, such as the Windows (tm) operating system and graphic user interface (GUI) environment. It should be understood that although certain operations, such as clicking on a button, selecting a group of items, drag-and-drop and the like, are described in the context of using a graphical input device, such as a mouse, it is within the scope of the invention that other suitable input devices, such as keyboard, tablets, and the like, could alternatively be used to perform the described functions. Also, where certain items are described as being highlighted or marked, so as to be visually distinctive from other (typically similar) items in the graphical interface, that any suitable means of highlighting or marking the items can be employed, and that any and all such alternatives are within the intended scope of the invention.

FIG. 2B illustrates a display screen image 220, according to another embodiment of the invention. A plurality of images are displayed in the form of an animated image as the content characteristic of each recorded program in the recorded program list. The fields 202 and 204 are suitably the same as in FIG. 2A. (Information in the field 202, a representative still image in the field 204.)

A preview window 224 is provided which displays the animated image for the video program which is currently highlighted by the cursor 206.

A progress bar 230 is provided which indicates where (temporally) the image displayed in the preview window 224 is located every time it is refreshed within the video stream highlighted by the cursor. The overall extent (width, as viewed) of the progress bar is representative of the entire duration of the video. The size of a slider 232 within in the progress bar 230 may be indicative of the size of a segment of the video being displayed in the preview window, or may be of a fixed size. The position of the slider 232 within the progress bar 230 is indicative of the position of the animated image for the video program which is currently highlighted by the cursor 206.

The content characteristics 224 used to guide the users to their video of interest may also be the video stream itself shown in a small size. Showing the video stream in a small size is the same as with the case of showing the animated image, as discussed hereinabove, but with a small modification. A still image representing each recorded program is displayed in 204 and the video stream highlighted by the cursor 206 is played in 224 and the displayed video in small size in 224 can be rewinded (rewound) or forwarded by pressing an arbitrary button on a remote control. For example, the Up/Down button in a remote control could be utilized to scroll between different video streams in a program list and the Left/Right button could be utilized to fast forward or rewind the highlighted video stream by cursor 206. This thus enables fast navigation through multiple video streams in an efficient manner. Also the progress bar 230 displays which portion of the video is being played within the video stream highlighted by the cursor.

FIG. 2C illustrates a display screen image 240, according to another embodiment of the invention. This embodiment operates the same as in the embodiment of FIG. 2A by displaying the content characteristics of each recorded program in the recorded program list, but a live broadcast window 244 is added where the currently broadcast live stream is displayed.

Thus there is provided a technique for selecting a video program from a plurality of video programs. This feature may be employed as a stand-alone feature, or in combination with other features for manipulating video programs that are disclosed herein.

II. Fast Navigation of Time-Shifted Video

According to this aspect of the invention, a technique is provided for the user to be able to view a time-shifted live stream while watching what is being currently being broadcast in real time

U.S. Pat. No. 6,233,389 (“Barton”) discloses a multimedia time warping system which allows the user to store selected television broadcast programs while the user is simultaneously watching or reviewing another program. U.S. Pat. No. RE 36,801 (“Logan”) discloses a time delayed digital video system using concurrent recording and playback. These two patents disclose utilizing an easily manipulated multimedia storage and display system such as for a digital video recorder (DVR) that allows a user to instantly pause and replay live television broadcast programs as well as the option of instantly reviewing previous scenes within a broadcast program. Therefore it allows functions such as reverse, fast forward, play, pause, fast/slow reverse play, and fast/slow play for a time-shifted live stream that is stored in temporary buffers. However, whenever a user wants to watch a video stream from where the pause button has been pressed or a user wants to perform the instantaneous playback from a predetermined amount of time beforehand, a user cannot concurrently watch what is being currently being broadcast in real time in case a DVR contains a single video decoder. Such functionality would be desirable, for example, in cases such as in sports programs, such as baseball, where a user is more interested in the live broadcast video program unless an important event such as home-run had occurred from the point a pause button has been pressed or from a predetermined amount of time beforehand in case a user accidentally forgot to press the pause button.

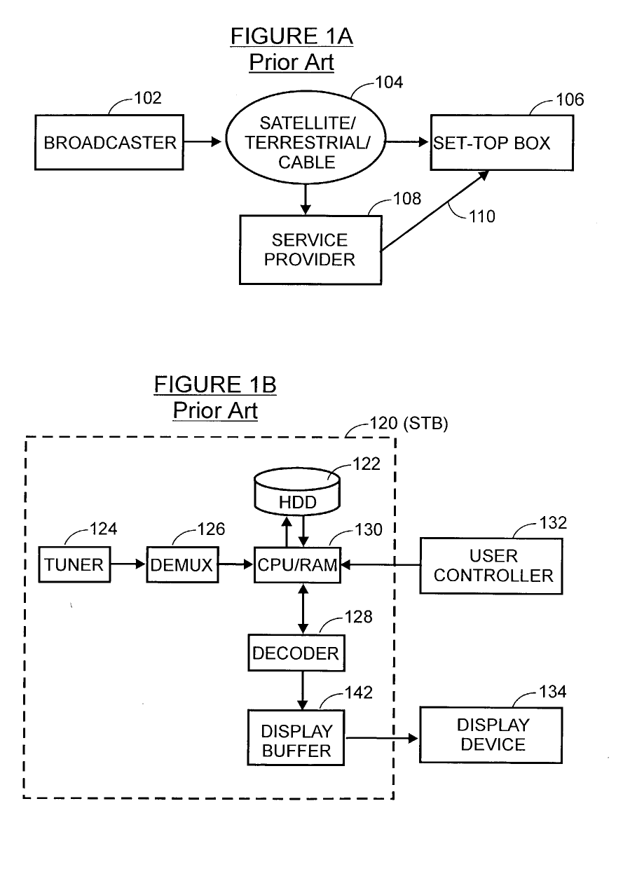

FIG. 3 is a block diagram illustrating a digital video recorder (DVR). The DVR comprises a CPU 314 and a dual-port memory RAM 312 (comparable to the CPU with RAM 130 in FIG. 1B), and also includes a HDD 310 (compare 122) and a DEMUX 316 (compare 126) and a user controller 332 (compare 132). The dual-port RAM 312 is supplied with compressed digital audio/video stream for storage by either of two pathways selected and routed by a switcher 308. The first pathway comprises the tuner 304 and the compressor 306 and is selected by 308 when an analog broadcast stream is received. The analog broadcast signal is received from tuner 304 and the compressor 306 converts the signal from analog to digital form. The second pathway comprises the tuner 302 and a DEMUX 316 and is selected in case the received signal is digital broadcast stream. The tuner 302 receives the digital broadcast stream and packets of the received digital broadcast stream are reassembled (such as which was MPEG-2 encoded-multiplexed) and is sent directly to RAM 312 since the received broadcast stream is already in digital compressed form (no compressor is needed).

FIG. 3 illustrates one possible approach to solving the problem of watching one program while watching another by utilizing two decoders 322, 324 in which one decoder 324 is responsible for decoding a broadcast live video stream, while another decoder 322 is used to decode a time-shifted video stream from the point a pause button has been pressed (user input), or from a predetermined amount of time beforehand from a temporary buffer. This approach requires two full video decoder modules 322 and 324 such as commercially available MPEG-2 decoder chip. The decoded frames are stored in display buffer 342 which may be displayed concurrently in the form of (picture-in-picture) PIP, on the display device 320.

FIG. 3 also illustrates an approach to using a full decoder chip 322 for generating reduced-size images while using another full decoder chip 324 to view a program.

According to the invention, a time-shifted video stream is decoded to generate reduced-sized images/video through a suitable derivation algorithm utilizing either a CPU (e.g., the CPU of the DVR) or a low cost (partial) video decoder module, in either case, as an alternative to using two full video decoders. The invention is in contrast to, for example, the DVR of FIG. 3 which utilizes two full video decoders 322, 324.

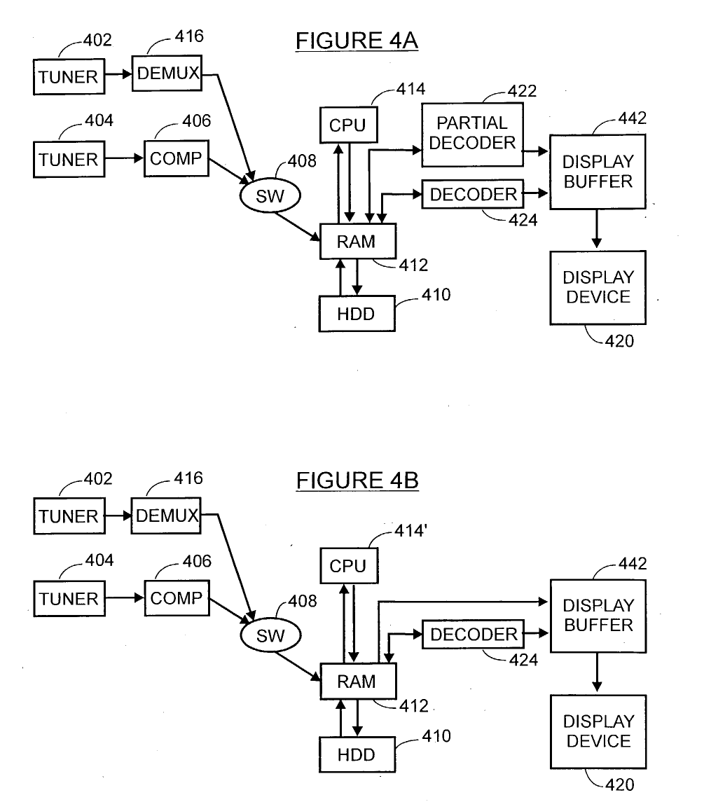

FIGS. 4A and 4B are block diagrams illustrating two embodiments of the invention. The “front end” elements 402, 404, 406, 408, 410, 412, 414, 416 may be the same as the corresponding elements 302, 304, 306, 308, 310, 312, 314, 316 in FIG. 3. In this, and subsequent views of DVRs, the user controller (132, 332) may be omitted, for illustrative clarity. In both figures, a full decoder chip 424 (compare 324) is used to store decoded frames in the display buffer 442 to view a program on a display device 420 (compare 320).

In FIG. 4A, partial/low-cost video decoder 422 is used to generate reduced-size images (thumbnails), rather than a full video decoder chip. In FIG. 4B, the CPU 414′ of the DVR is used to generate the reduced-size images, without requiring any decoder (either partial or full). Thus, in FIG. 4B, a path is shown from the RAM 412 to the display buffer 442. FIG. 4A represents the “hardware” solution to generating reduced-size images, and FIG. 4B represents the “software” solution. In the hardware solution, the partial decoder 422 is suitably implemented in an integrated circuit (IC) chip.

As mentioned above, advantages accrue to the use of a partial/low-cost video decoder (e.g., 422) to generate reduced-size images (thumbnails), rather than a full video decoder chip (e.g., 322). Using such a low-cost decoder (e.g., 422), reduced-size images (thumbnails) can be generated by partially decoding the desired temporal position of video stream by utilizing only a few coefficients in compressed domain. The low-cost decoder can also partially decode only an I-frame near the desired position of the video stream without also decoding P and B frames which is enough for a variety of purposes such as video browsing.

Given a DVR system, such as illustrated in FIG. 3 or FIG. 4, a user has to constantly press the reverse or fast forward to skim through the time-shifted video, displayed in the form of PIP along with the currently broadcast program, from the point a pause button has been pressed or predetermined amount of time beforehand to check if something important has occurred for playback. Therefore, it would be advantageous to have a functionality which allows a user to easily and quickly browse a video being recorded for time-shifting if any important event has occurred from the point a pause button has been pressed or a predetermined amount of time beforehand and which allows the user to playback from important events if any has occurred and, if not, simply continue watching the currently broadcast live video.

In response to a user input, such as when a dedicated button for our proposed invention is pressed, the key frame images of a video segment are generated through 322 or 422 or 414′ and displayed on 320 or 420. Note that the 424 and 324 are utilized to fully decode the currently broadcast stream. The video segment from where the key frame images are generated correspond to a video segment from where a pause button was pressed to the instance the dedicated button is pressed. The video segment described hereinabove can also correspond to a video segment from a predetermined time (for example, 5 seconds) before and to the instance the dedicated button is pressed.

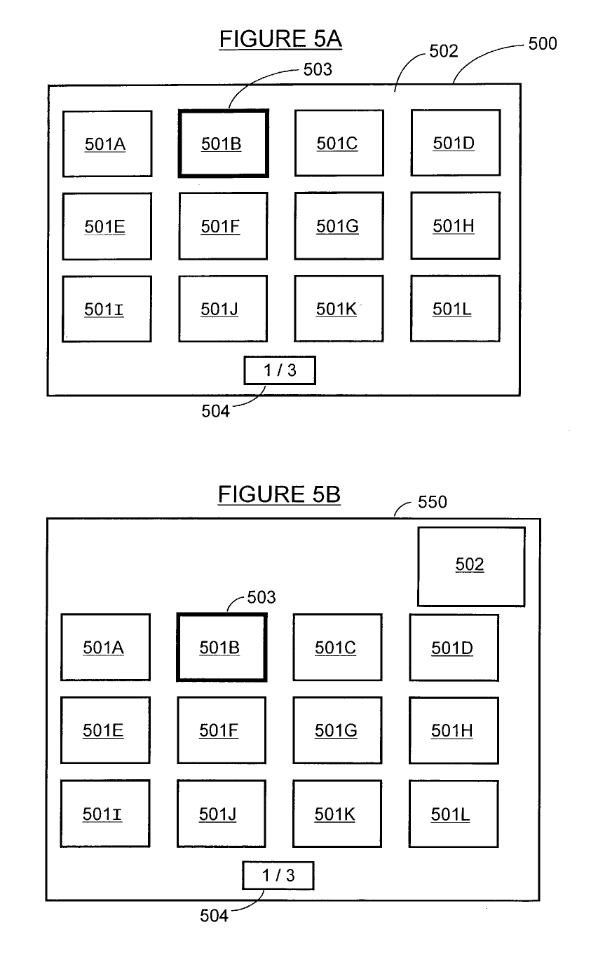

FIG. 5A is a graphical illustration of the resulting display image 500. The plurality of key frame images 501 (A . . . L) can be generated from the video segment corresponding to a predetermined time (for example, 5 seconds) before a remote control is pressed to the instant a button is pressed. The key frame images can suitably take the form of half-transparent images such that the currently broadcast video stream 502 being concurrently displayed underneath can be viewed by a user. Each of the plurality of key frame images (501A . . . 501L) is contained in what is termed a “window” in the overall image.

Alternatively, as illustrated in the display image 550 of FIG. 5B, the video stream that a user is currently watching can be displayed in an area of the image separate from the key frame images 501, such as in a small sized window 502, rather than underneath the key frame images. This is preferred if the key frame images 501 are opaque (rather than half-transparent). The rest of the user interface operates the same way as described with respect to FIG. 5A. If a user decides (based on the displayed key frame images) that an important event has not occurred, the user simply needs to press a specified button (e.g., on 132) to hide the key frame images from the display and watch the currently broadcast video stream.

In the event that a user decides that an important event has been missed from the location a pause button has been pressed through the displayed key frame images, the user simply needs to move the highlighted cursor 503 to the key frame image of interest through a remote control from where the video stream is played from the location the selected key frame image is mapped in the stored video in the buffer and the key frame images are hidden.

In the likely event that there are many more key frame images than can comfortably be displayed at once on the screen, the key frame images are stored on pages (as sets) which are numbered sequentially for a set of images on time basis (arranged in temporal order). An area 504 of the display image (500, 550) displays the total number of key frame pages (in this example, “3”), and the current page (in this example “1”) of the key frame images being displayed (501A-L). (Page 1/3=page 1 of 3, or “set” 1 of 3.)

To navigate to the next page (set) of key frame images (in this example, page “2” of “3”), the user may simply move the highlighted cursor 503 to the right in the bottom right most corner, so that the next set of key frame images will be displayed, and the index numbers in the area 504 is updated accordingly. To view a previous page (set) of key frame images, the user can move the cursor to the top left most corner of the current display so that the previous set of key frame images will be displayed, and the index numbers will be updated accordingly. In any case, for navigating between sets of key frame images, the user moves the cursor to a selected area of the display. Alternatively, selecting the last key frame (e.g., 501L) of a given set can cause the next set, or an overlapping next set (a set having the selected frame as other than its last frame), to be displayed. Conversely, selecting the first key frame (e.g., 501A) of a given set can cause the previous set, or an overlapping previous set (a set having the selected frame as other than its last frame), to be displayed.

III. Video Bookmarking

Video bookmark is a feature that allows a user to access a recorded content at a later time from the position of the multimedia file a user has specified. Therefore, the video bookmark mark stores the relative time or byte position from the beginning of a multimedia content along with the file name. Additionally the video bookmark can also store a content characteristic such as an image extracted from the video bookmark position marked by the user as well as icon showing genre of the program such that the user can easily reach the segment of interest through the title of the video bookmark displayed along with the stored image of the corresponding location.

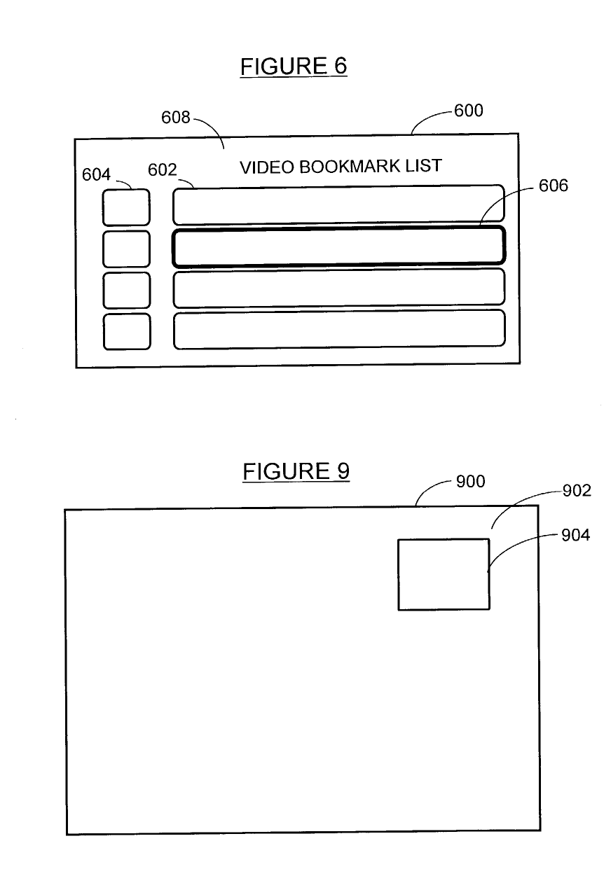

FIG. 6 (compare FIGS. 2A, 2B, 2C; Program List) is a graphic representation of a display screen 600, illustrating a list of video bookmark (VIDEO BOOKMARK LIST) where 604 (compare 204) are the thumbnail images for the video bookmarks, and the field 602 (compare 202) comprises information such as the title, recording time, duration, the relative time of the video bookmark position and channel. The user thus can move the highlighted cursor 606 (compare 206) upwards or downwards to select the video bookmark of interest for playback from the corresponding location specified by the video bookmark.

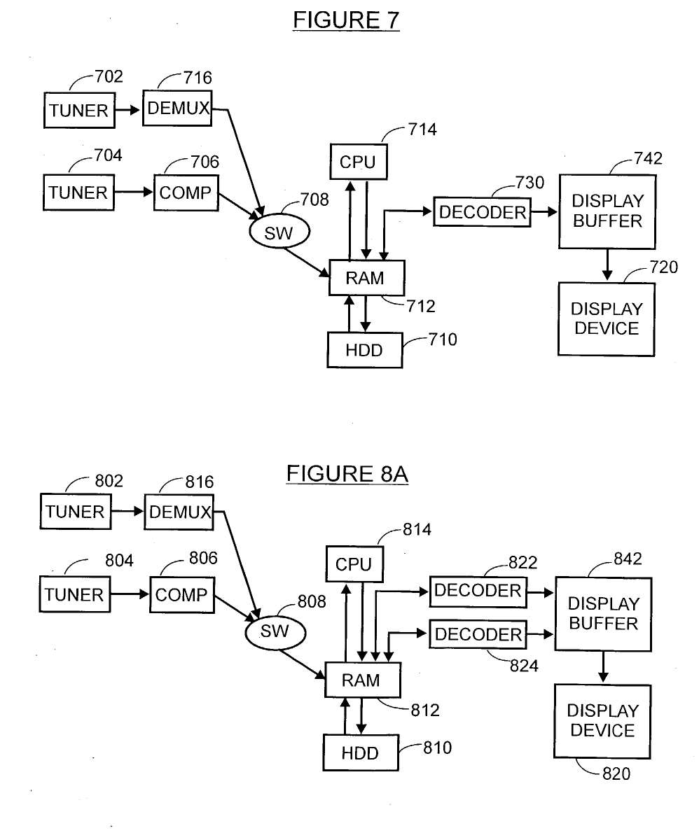

FIG. 7 (compare FIG. 3) is a simplified block diagram of a DVR. The DVR comprises two tuners 702, 704, a compressor 706, switcher 708, a HDD 710, a DEMUX 716 and a CPU 714 with RAM 712, comparable to the previously recited elements 302, 304, 306, 308, 310, 316, 314 and 312, respectively. A display device 720 and display buffer 742 are comparable to the aforementioned display device 320 and display buffer 342, respectively.

In the case that a single full decoder 730, such as MPEG-2 Video Decoder chip is available in the DVR, it is mandatory that a video bookmark stores the images extracted from the video bookmark position since it is not possible to generate images 604 from the relative time or byte position stored in a video bookmark for displaying the video bookmark list while decoding and displaying a recorded or encoded program or currently transmitted video stream in the background 608 as in FIG. 6. Therefore, the images for the video bookmark are obtained from display buffer 742 or frame buffer in 730 in FIG. 7 at the instant a video bookmark is requested and stored on the hard disk. However, such a scenario is restricted in that only the currently displayed frame of a video stream can be video bookmarked since the previous frames are not available in the display buffer 742 or frame buffer in 730. Therefore, taking into consideration that a user is often not aware of what is going to be displayed in the future, there is a high possibility that the position a user wanted to mark as a bookmark has already passed after a user has realized that he wanted to mark a specific position. In such cases, it not possible to obtain the corresponding image of the video bookmark since it is not available in the display buffer 742 or frame buffer in 730 anymore.

Therefore, it would be advantageous if the image not currently available in the display buffer could be obtained for video bookmark.

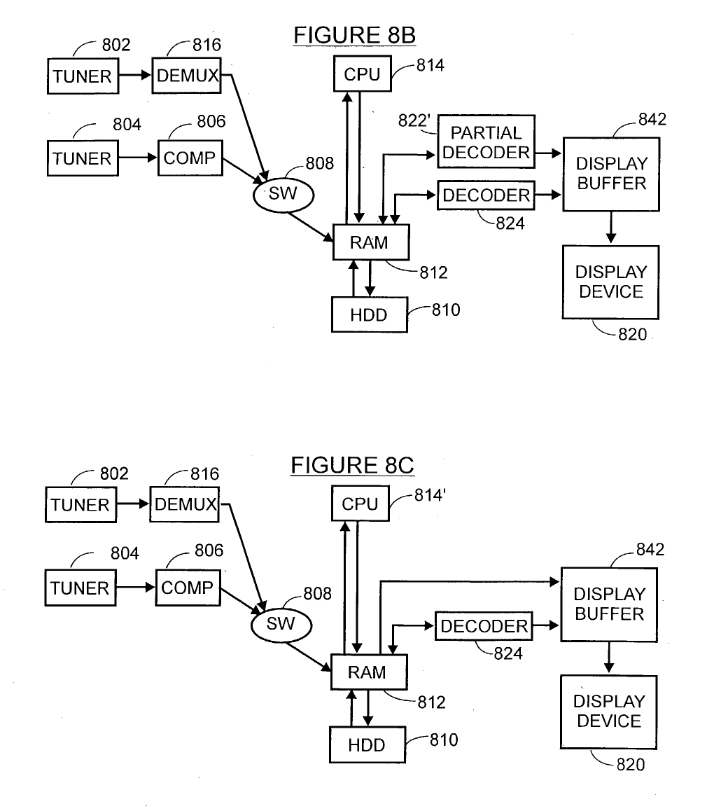

In FIG. 8A (compare FIG. 3) a DVR comprises two tuners 802, 804, a compressor 806, switcher 808, a HDD 810, a DEMUX 816 and a CPU 814 with RAM 812, comparable to the previously recited elements 302, 304, 306, 308, 310, 316, 314 and 312, respectively. A display device 820 is comparable to the aforementioned display device 420. A display buffer 842 is comparable to the aforementioned display buffer 742. This embodiment include a full decoder 824 (compare 324) which is used for playback.

In FIG. 8A, a full decoder 822 (compare 322) is dedicated for generating reduced-sized/full-sized images for a video frame that is not available in the display buffer for video bookmark. An advantage of generating the thumbnail of a video bookmark through a dedicated full decoder 822 is that the images for the video bookmarks do not need to be saved since the images can be generated through the decoder 822 from the bookmarked relative time or byte position from the beginning of a multimedia content along with the file name regardless of whether the full decoder 824 is being used for playback. Thus it reduces the space required to store the images and makes it easier to manage the video bookmark by keeping one file containing the info on a list of bookmarks.

In FIG. 8B the DVR uses a partial/low-cost decoder module 822′ (with “normal” CPU 814, compare FIG. 4A) dedicated for generating reduced-sized images, rather than decoding full-sized video frames to generate a reduced-size image for a video frame that is not available in the display buffer for video bookmark. The RAM and CPU can be combined, as shown in FIG. 1B (130).

In FIG. 8C the DVR uses the CPU 814′ (compare 814, compare FIG. 4B) itself, rather than a decoder for generating reduced-sized images, rather than decoding full-sized video frames to generate a reduced-size image for a video frame that is not available in the display buffer for video bookmark. A path is shown from the RAM 812 to the display buffer 842 for this case where the CPU is used to generate reduced-size images (compare FIG. 4B). The RAM and CPU can be combined, as shown in FIG. 1B (130).

One other advantage of generating the thumbnail of a video bookmark through the CPU or the low cost decoder module is that the images for the video bookmarks does not need to be saved since the images can be generated through the CPU or low cost decoder module from the bookmarked relative time or byte position from the beginning of a multimedia content along with the file name regardless of whether the full decoder is being used. Thus it reduces the space required to store the images and makes it easier to manage the video bookmark by keeping one file containing the info on a list of bookmarks.

FIG. 9 is a screen image 900 illustrating a display of a graphical user interface (GUI) embodiment of the present invention for the case when the video bookmark is made. If, while viewing a video, a user wants to store the current position corresponding to a frame of the video stream 902 for video bookmark, the user makes an input such as by pressing a dedicated key in the remote control. In response to the user input, a bookmark event icon 904 is displayed, such as in a corner of the current frame of the video stream, to indicate that a video bookmark has been made. Then, after a specified, limited amount of time (e.g., 1-5 seconds), the icon is removed.

The bookmark event icon 904 can be either a text message or a graphic message indicating that a video bookmark has been made. Alternatively, it can be a thumbnail generated by full decoder or CPU or partial/low cost decoder module front the position that the video bookmark has been made. The bookmark icon may be semi-transparent.

Since it is possible that the user makes his input for video bookmarking a few seconds after the position when the user actually wanted to bookmark, the video bookmark function could be arranged to make a bookmark corresponding to a position in the video stream which is a prescribed time, such as a few seconds, before the actual position a user has pushed the button. In such a case, the bookmark event icon 904 could be the image generated by full decoder or CPU or partial/low cost decoder module for a position corresponding to a few seconds before the position a user has made a video bookmark. Concurrently, the relative time or byte position of where the image was generated is stored in the video bookmark along with the file name. The prescribed time could readily be set by the user from a menu.

An alternative to making the bookmark correspond to a fixed, prescribed time before the user makes his input is to make the bookmark correspond to the beginning of the current shot/scene, using any suitable shot detection technique. Alternatively, the bookmark may correspond to the key frame for the current segment.

IV. Fast Accessing of Video Through Dynamic Displaying of a List of Key frames

Conventional video cassette recorders (VCRs) provide fast forward and rewind functionality to allow users to quickly reach a video segment of interest for playback within the VCR tape. However, it is often very hard to find the segment of interest if the fast forward functionality is either too slow, because it takes too much time to reach to the video segment of interest in case it is located at the end of the tape, or if the fast forward function is too fast, because the pictures presented one the display device are refreshed too fast and the user can hardly recognize the pictures. The same problems can arise equally when a fast rewind function is to be used to find a video segment of interest. The fast forward and rewind functions are provided by the digital video recorders (DVRs) for the digital video stream which is stored in the hard disk (HDD). However, digital video streams have the inherent advantage that they can be randomly accessed. Thus, new functionalities which are not provided by the VCR can be achieved for fast accessing the video segment of interest in the DVR.

According to this embodiment of the invention, a method is provided for fast accessing a video segment of interest using a DVR.

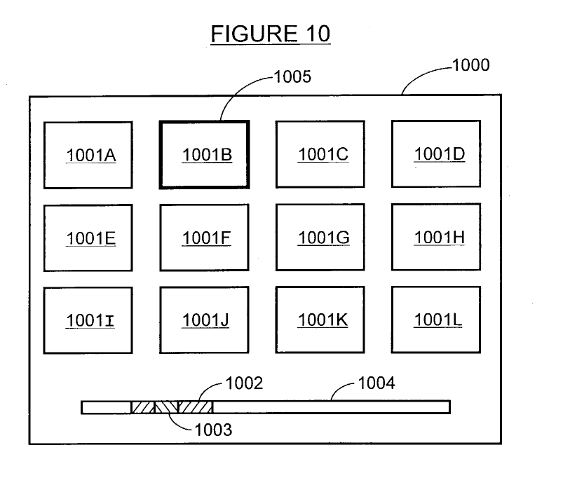

FIG. 10 is a representation of a display screen image 1000, illustrating an embodiment of the invention for fast accessing a video segment of interest. Preferably this is done with a DVR, on a stored video program. When a user makes an input, such as by pressing a designated button on a remote control for fast accessing a video segment of interest, a plurality of key frame images are extracted from an arbitrary uniformly spaced time interval or through an appropriate derivation algorithm, and are displayed. In this example, a set of twelve key frame images 1001A . . . 1001L are displayed in sequential order based on time, starting from the top left corner to the bottom right corner of the display. (Compare, for example, the display of key frame images 501 in FIGS. 5A and 5B, each within its own “window”.) The set of key frame images are thus utilized as the point of access to the video segment of interest for playback where each thumbnail image is a representative image extracted from each video segment. For example, if a thumbnail image is extracted for every 2 minute interval (segment) in the video stream, the user can therefore decide whether the video segment of interest exits for a video segment corresponding to 24 minutes of length at a glance through the displayed key frame images. This timed-interval approach is reasonable and viable because a video segment typically tends to last a few minutes, and thus an image extracted from a video segment is generally sufficiently representative of the entire video segment.

A progress bar 1004 (hierarchical slide-bar) is shown at the bottom of the display 1000. The overall length of the bar 1004 represents (corresponds to) the overall (total) length of the stored video program. A visually-distinctive (e.g., green) indicator 1002, which is a fraction of the overall bar length, represents the length of the video segment covered by the entire set of (e.g., 12) key frame images which are currently being displayed. A smaller (shorter in length), visually-distinctive (e.g., red) indicator 1003 represents the length of the video segment of the key frame image indicated by the highlighted cursor 1005.

The user can freely move the highlighted cursor 1005 to select the video segment of interest for playback through moving the highlighted cursor 1005 to the key frame image and pressing a button for playback. A new set of key frame images are displayed if the highlighted cursor is moved right when the highlighted cursor is indicating the bottom right most key frame image (1001L) or left when the highlighted cursor is indicating the top left most corner key frame image (1001A). (Compare navigating to the next and previous pages of key frame images, discussed hereinabove.)

This technique (e.g., hierarchical slide-bar) is related to the subject matter discussed with respect to FIG. 61 of the aforementioned U.S. patent application Ser. No. 09/911,293. For example, as described therein,

Referring back to FIG. 61, FIG. 61 further contains a status bar 6150 that shows the relative position 6152 of the selected video segment 6120, as illustrated in FIG. 61. Similarly, in FIG. 62, the status bar 6250 illustrates the relative position of the video segment 6120 as portion 6252, and the sub-portion of the video segment 6120, i.e., 6254, that corresponds to Tiger Woods' play to the 18th hole 6232.

Optionally, the status bar 6150, 6250 can be mapped such that a user can click on any portion of the mapped status bar to bring up web pages showing thumbnails of selectable video segments within the hierarchy, i.e., if the user had clicked on to a portion of the map corresponding to element 6254, the user would be given a web page containing starting thumbnail of Tiger Woods' play to the 18th hole, as well as Tiger Woods' play to the ninth hole, as well as the initial thumbnail for the highlights of the Masters tournament, in essence, giving a quick map of the branch of the hierarchical tree from the position on which the user clicked on the map status bar.

In contrast to this technique, U.S. Pat. No. 6,222,532 provides only an indicator which specifies the total length of the set of key frames currently displayed on the screen.

In an alternate embodiment of the invention, the key frame images are generated and displayed in the same manner as described hereinabove, but the video segment can be fast forwarded or rewound such that the user can exactly reach the position for playback where else the conventional method plays from the beginning of video segment corresponding to the selected key frame image and the user needs to additionally fast forward or rewind the video shown in full size to reach to the exact position of interest for playback. Problems arise when the selected video segment does not contain the video segment of interest and the user again needs to select the video segment of interest for playback through the key frame images. This problem arises because a key frame image sometimes does not sufficiently convey the semantics of the video segment which it is representing. Therefore it would be advantageous if the user could access the content of the video segment.

Therefore, according to an aspect of the invention, when the highlighted cursor 1005 remains idle on a key frame image (e.g., 1001B) for a predetermined amount of time, such as 1-5 seconds, the video segment of the corresponding key frame is played in reduced size (within the window) and the user is allowed to fast forward or fast rewind the video segment which is displayed in small size within the window of the highlighted cursor 1005. When a user finds the exact location of interest for playback within the small image, the user makes an input (e.g., presses a button on the remote control) to indicate that the exact position for playback has been found and the user interface is hidden and the video which was being shown in small (reduced) size is then continuously shown in full size. In case the user cannot find the exact location of interest for playback in the video segment of the key frame image, the user can repeatedly move the highlighted cursor to a new key frame image which might contain the video segment of interest.

In an alternate embodiment of the invention, a hierarchical summary based on key frames of a given digital video stream are generated through a suitable derivation algorithm. A hierarchical multilevel summary which is generated through a given derivation algorithm are displayed as in FIG. 10. Firstly, the key frames 1001 corresponding to the coarsest level are displayed. When a user wants to see a finer summary of a video segment associated with the key frame image, the user moves the highlighted cursor 1005 to the key frame image of interest and makes an input (e.g., a designated button on a remote control is pressed) for a new set of key frame images 1001 corresponding the finer summary of the selected key frame image. In such process, an indicator such as 1002 and 1003 are newly added one-by-one with different colors which represent the length of the video segment, the set of key frame images are representing, when a user presses for a finer summary of a key frame image. Conversely, the recently added indicator is removed when a user presses for a coarser level of summary where the key frames of the previous level are shown.

V. Backward Recording Using Time Shifting Area

Some digital video recorders (DVRs) provide a feature allowing scheduled recording of programs that are selected by users. The recording starts and ends based on the start and end times described in the Electronic Programming Guide (EPG) that is also delivered to DVR. They also provide a feature called time shifting that always records a fixed amount, for example 30 minutes of a live broadcast video stream, into a predetermined part of the hard disk for the purpose of instant replay or trick play

Sometimes a user will start recording a live broadcast video while watching it, to preserve meaningful events, such as baseball homeruns or football touchdowns, so that the event can be watched afterwards. However, in live broadcast such meaningful events are hard to be recorded since such events happen instantaneously and users cannot predict exactly when such events will happen in the future. Therefore the beginnings of such events are often missed for recording since the event has either finished or has already started by the time a “record” button is pressed for recording.

According to the invention, when a user pushes the instant recording button on a user controller (e.g., 132) such as a remote control, a predetermined amount of stream stored in the time shifting area allocated in the hard disk is shifted to the recording area. The present invention discloses two methods of moving the stream in the time shifting area to the recording area. The first method is used when using the static time shifting area in a DVR. The second method is used when using the dynamic time shifting area in a DVR.

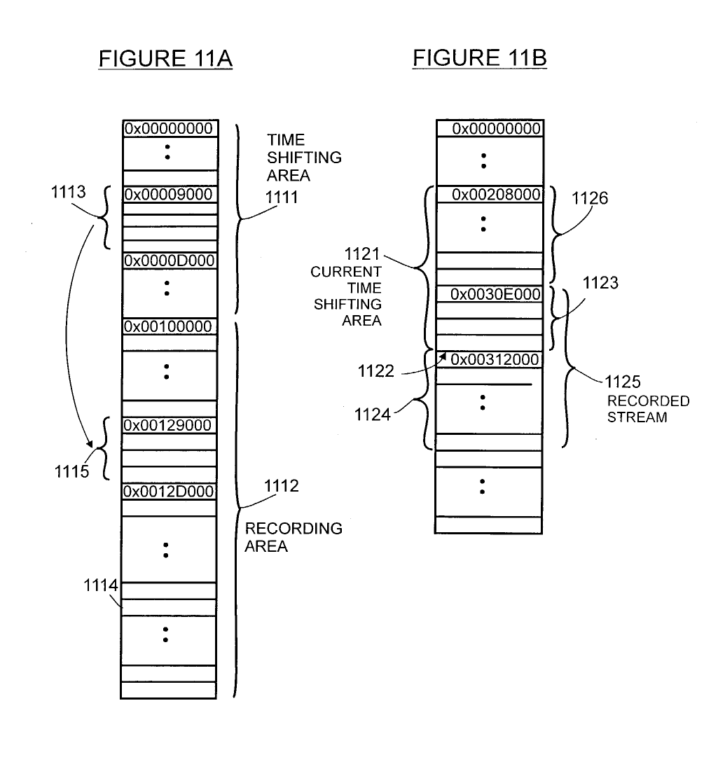

FIG. 11A illustrates an embodiment where a static time shifting area is used in a DVR in a way that the static time shifting area 1111 is partitioned physically or logically differently from the recording area 1112 in the hard disk (HDD). In this case, the stream 1113 corresponding to a part of a video stream with duration prolonging from a predetermined time before the instant recording button is pressed to the instant the instant recording is pressed stored in time shifting area of the hard disk is copied into the recording area 1115 upon user's request for the instant recording. However, since the live broadcast stream needs to be recorded in the recording area while copying a portion of the stream 1113 in the time shifting area, the live broadcast stream 1114 is recorded after a specified amount of space such that a portion of the stream 1113 in the time shifting area 1111 could be copied while the live broadcast stream 1114 is being recorded.

FIG. 11B illustrates an embodiment of the invention where the time shifting area 1121 is dynamically allocated from the empty space available in the hard disk. If the user starts instant recording, then the stream 1123 that corresponds to a predetermined amount (e.g., 5 seconds of viewing) in the time shifting area 1121 does not have to be moved. The live broadcast video stream 1124 is appended thereafter from 1122 for recording while the stream 1126 in 1121 that is not used anymore is de-allocated and then the time shifting area is newly allocated. Therefore the stream in the recording area 1125 is the final recorded stream. Therefore, even if the recording button is pressed after an event has started, the event can be recorded without the beginning of the event being missed.

VI. Channel Browsing Using User Preference

The number of channels delivered for digital broadcasting is growing in leaps and bounds, therefore making it increasingly difficult for TV viewers to efficiently browse broadcast channels. Thus, viewers desire to view multiple channels of their interests simultaneously. The conventional picture-in-picture (PIP) system usually allows users to view another channel while they are watching a given channel.

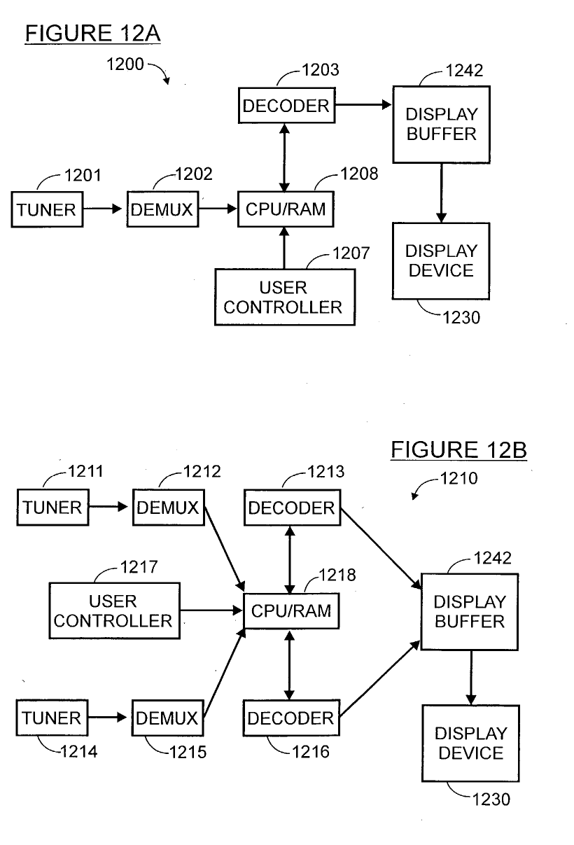

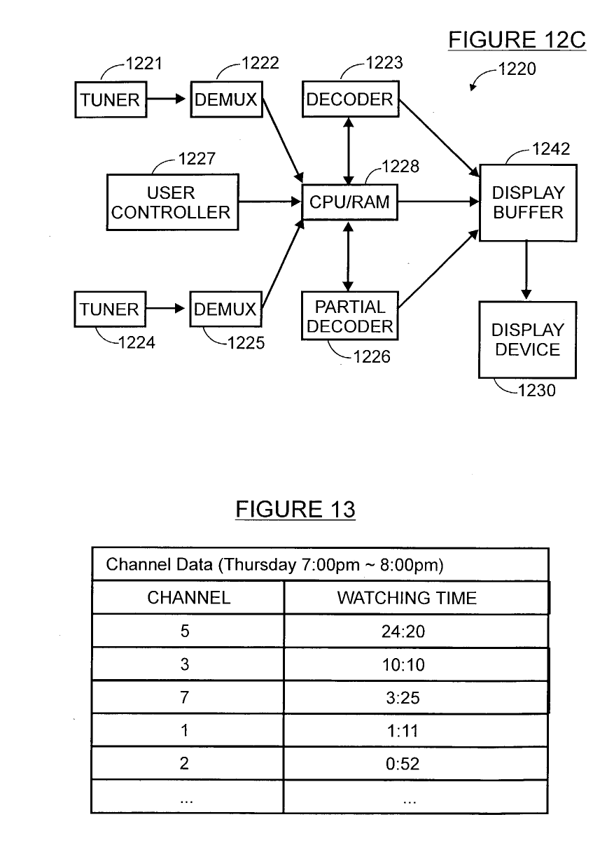

FIG. 12A illustrates an embodiment of the invention showing a block diagram of a channel browser 1200. In this case, one tuner demodulates multiplexed streams. If a user desires to browse live broadcast streams, the user makes an input (e.g., pushes a channel browser button on a remote control device 1207) and selects a number of channels (or possibly with the default number of channels preset) to browse. Then the live broadcast streams to be browsed from a tuner 1201 and a demultiplexer 1202 are sent to decoder 1203. Then the video frames of the live digital broadcast streams to be browsed decoded by decoder 1203 appears on the display device 1230. The decoder 1203 generates temporally sampled reduced-size (thumbnail) images from the streams. The reduced-size images are stored in display buffer 1242 and displayed on the display device 1230 for the purpose of channel browsing.

FIG. 12B illustrates an another embodiment of the invention showing a block diagram of a channel browser 1210 which allows users watch the currently broadcast live stream while browsing other broadcast live channels. In this case, one tuner demodulates multiplexed streams. A live broadcast stream from a tuner 1211 and a demultiplexer 1212 is sent to decoder 1213. Then the video frames of the main live digital broadcast stream decoded by decoder 1213 appears in a on the display device 1230. If a user desires to browse other channels, the user makes an input (e.g., pushes a channel browser button on a remote control device 1217) and selects a number of channels (or possibly with the default number of channels preset) to browse. For browsing other channels, the system uses another tuner 1214 and demultiplexer 1215 to pass the video streams to the decoder 1216. The decoder 1216 generates temporally sampled reduced-size (thumbnail) images from the streams. The reduced-size images are stored in display buffer 1242 and displayed on the display device 1230 in the form of PIP for the purpose of channel browsing.

FIG. 12C illustrates an another embodiment of the invention showing a block diagram of a channel browser 1220 which allows users watch the currently broadcast live stream while browsing other broadcast live channels. In this case, one tuner demodulates multiplexed streams. A live broadcast stream from a tuner 1221 and a demultiplexer 1222 is sent to decoder 1223. Then the video frames of the main live digital broadcast stream decoded by decoder 1223 appears on the display device 1230. If a user desires to browse other channels, the user makes an input (e.g., pushes a channel browser button on a remote control device 1227) and selects a number of channels (or possibly with the default number of channels preset) to browse. For browsing other channels, the system uses another tuner 1224 and demultiplexer 1225 to pass the video streams to the low cost (partial) decoder module 1226 or a CPU in CPU/RAM 1228. As discussed with reference to previous embodiments, either the low cost (partial) decoder module 1226 or a CPU in 1228 generates temporally sampled reduced-size (thumbnail) images from the streams. The reduced-size images are stored in display buffer 1242 and displayed on the display device 1230 in the form of PIP for the purpose of channel browsing.

The CPU in CPU/RAM 1208,1218,1228 controls the frequency of thumbnail generation and also the order and range of channels which are browsed. Given that users tend to have viewing habits, and typically will want to watch their favorite channels more frequently, the user's favorite channels are more frequently tuned.

According to an aspect of the invention, when the user initiates the “browse” function (as described above), the CPU can select frequently tuned channels using the information on user preference obtained from analyzing user history, since user history contains the information on favorite channels, the programs they tend to like and the times they watch. The frequency of channel selection can be determined as users frequently watch programs of the channels. In order to survey the frequency of channel selection, the user history data have to be stored in permanent storage devices such as hard disk or flash ROM since such data needs to be retentive even after a power disruption. Alternatively, the favorite channels and the frequency can be simply determined/preset by a user.

FIG. 13 (see also the following TABLE I) illustrates an embodiment of the invention showing an example of the sorted channel data using the user history. The system collects the user history of channel data and computes the total length of time that the user watched the channels. The column “watching time” in TABLE I corresponds to the total length of time a user has watched the corresponding channel between the hours of 7:00 p.m and 8:00 p.m on Thursday. Therefore, if a user wants to perform channel browsing at 7:00 pm on Thursday, the particular channels which are browsed can be tailored to the user's viewing habits by obtaining this information from the user history, such as in TABLE I. Here it is evident that the user watches five channels (5, 3, 7, 1, 2) between the hours of 7:00 p.m and 8:00 p.m on Thursday, and that he has watched channel 5 that most during that time period. This information can be displayed to the user and edited, for example if the user desires to eliminate a particular entry from the table.

TABLE I
CHANNEL DATA (THURSDAY 7:00 pm-8:00 pm)

| CHANNEL | WATCHING TIME |
|---|---|
| 5 | 24:20 |
| 3 | 10:10 |
| 7 | 3:25 |
| 1 | 1:11 |
| 2 | 0:52 |
| . . . | |

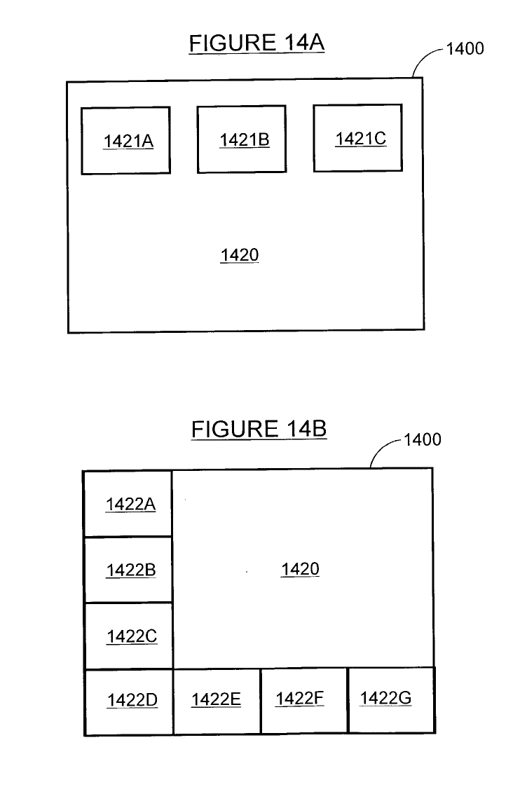

FIG. 14A and FIG. 14B illustrate an embodiment of the invention showing two examples of screens 1400 for channel browsing. The live broadcast is displayed in 1420 on the screen of the display device 1230. In FIG. 14A three small windows 1421A, 1421B and 1421C are shown on the screen (e.g., of the display device 1230). Favorite channels and services may be tuned and displayed more frequently in the order of user's channel preference in the small windows 1421A to 1421C. As an example, channel and service may be tuned and displayed more frequently in the order of user's channel preference from 1421A to 1421C. In FIG. 14B seven small windows 1422A . . . 1422G are shown on the screen (e.g., of the display device 1230). As in FIG. 14A the channel and service may be tuned and displayed more frequently in the small windows 1421A. 1421G in the order of user's channel preference from 1421A to 1421G. Visual attributes of windows between 1421A and 1421C in FIGS. 14A and 1422A and 1422G in FIG. 14B may be indicative of viewer preference—for example, transparency, size, borders around the windows, contrast, brightness, etc. It should also be noted that the orientation and the order of user's viewing preference may be varied for the small windows (1421A . . . 1421C, 1422A. . . . 22G) in FIG. 14A and FIG. 14B.

VII. The EPG Display Using User Preference and User History

The electronic program guide (EPG) provides the program information of all available channels being broadcast. However, since the number of channels is typically in the hundreds, efficient ways of displaying the EPG are needed to display it using the graphic user interface (GUI) in a STB system. Since the GUI is limited as to the amount of information it can provide in a given video display size, it is very hard for a user to quickly browse all of the programs which are currently being broadcast. Therefore, conventional methods categorize the broadcast programs into a set of specified genres (for example, movie, news and sports) such that a user can select a genre in the GUI and the GUI displays the set of channel/programs information corresponding to the selected genre. However, the selected genre can still contain several related channel/programs, and the user needs to scroll up/down the list of related channel/programs to view the entire list.

According to the invention, in order to alleviate the problem of there being more programs to list than are comfortably viewed in a single screen, a list of TV channel programs can be displayed in the order of user preference. One way of determining such favorite channels is simply by using a list of favorite channels which is specified by the user. Therefore, the channels specified as the favorite channels are prioritized and displayed before other channels and can fast guide users to the programs of interest. Alternatively, the user's favorite channels can be prioritized automatically by analyzing user history data and tracking the channels of interest automatically according to individual STB users.

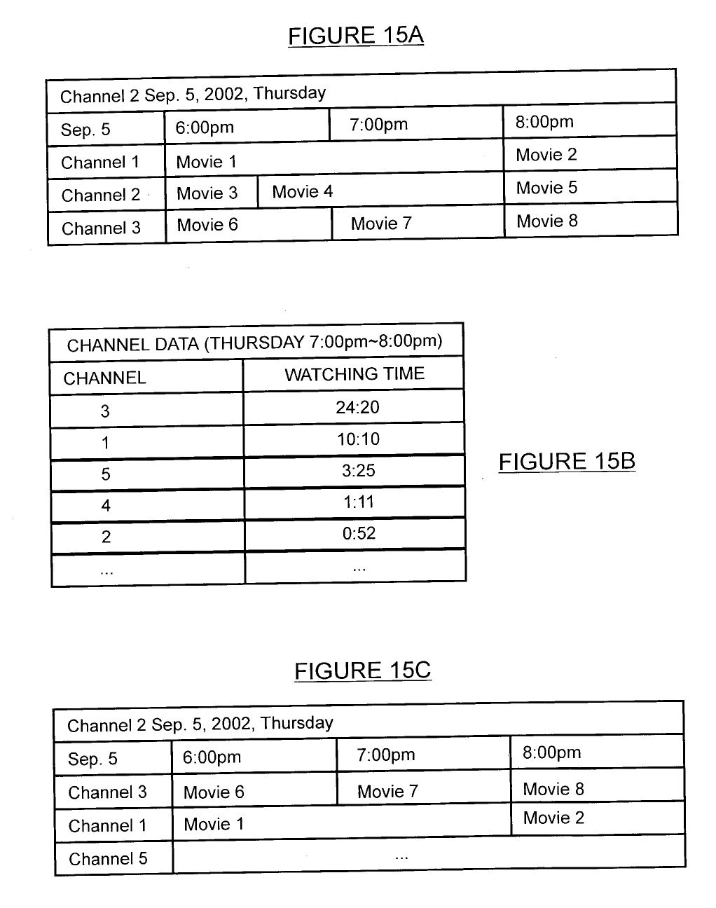

FIG. 15A (see also TABLE II) illustrates a portion of a conventional EPG display on a TV screen. The channels are simply presented in order (1, 2, 3 . . . ).

TABLE II

| Channel 2 Sep. 5, 2002, Thursday | | | | |
|---|---|---|---|---|
| Sep. 5 | 6:00 pm | | 7:00 pm | 8:00 pm |
| Channel 1 | Movie 1 | | | Movie 2 |
| Channel 2 | Movie 3 | Movie 4 | | Movie5 |
| Channel 3 | Movie 6 | | Movie 7 | Movie 8 |

FIG. 15B (see also TABLE III) illustrates collecting information regarding a user's channel-viewing history/preferences. By analyzing a user's history data, which may be stored in the non-volatile local storage in a STB, the information on user preference can be obtained. Therefore, if a user wants to check EPG data between 7:00 pm and 8:00 pm on Thursday, the particular channels which are frequently browsed can be identified by obtaining this information from the user history, such as in TABLE III.

TABLE III
CHANNEL DATA (THURSDAY 7:00 pm˜8:00 pm)

| CHANNEL | WATCHING TIME |
|---|---|
| 3 | 24:20 |
| 1 | 10:10 |
| 5 | 3:25 |
| 4 | 1:11 |
| 2 | 0:52 |
| . . . | . . . |

FIG. 15C (see also TABLE IV) illustrates an EPG GUI, according to the invention, showing the favorite channels in the user's order of preference based upon the results as displayed in FIG. 15B so that the user does not need to scroll up and down to find his/her favorite channels.

TABLE IV

| Channel 2 Sep. 5, 2002, Thursday | | | |
|---|---|---|---|
| Sep. 5 | 6:00 pm | 7:00 pm | 8:00 pm |
| Channel 3 | Movie 6 | Movie 7 | Movie 8 |
| Channel 1 | Movie 1 | | Movie 2 |

| | |
|---|---|
| Channel 5 | . . . |

VIII. Method and Apparatus of Enhanced Video Playback using Updated EPG

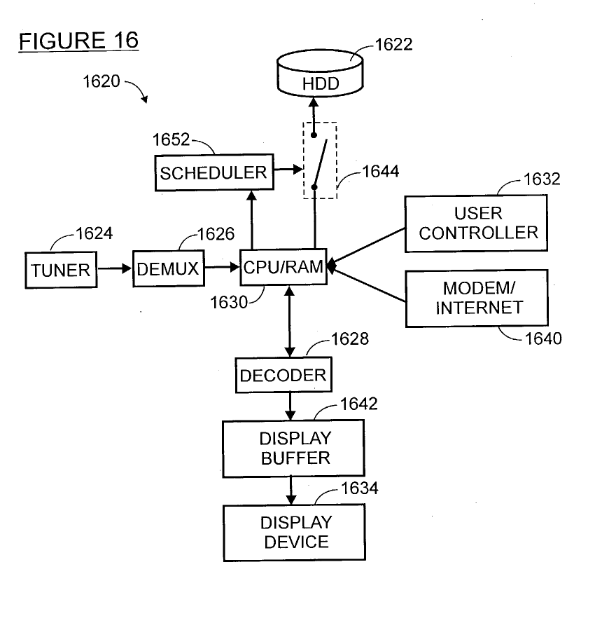

FIG. 16 illustrates showing a scheduled recording in set-top box.

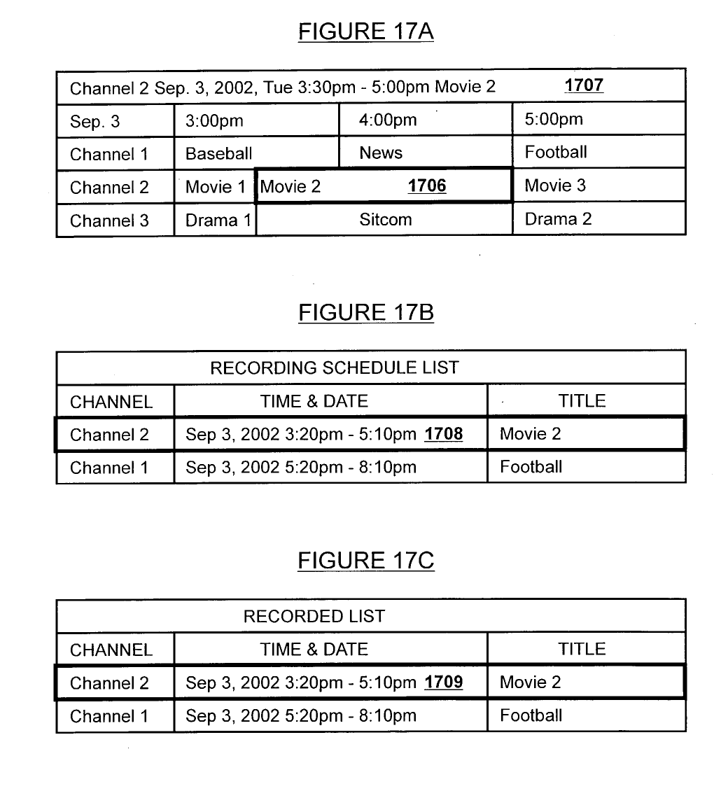

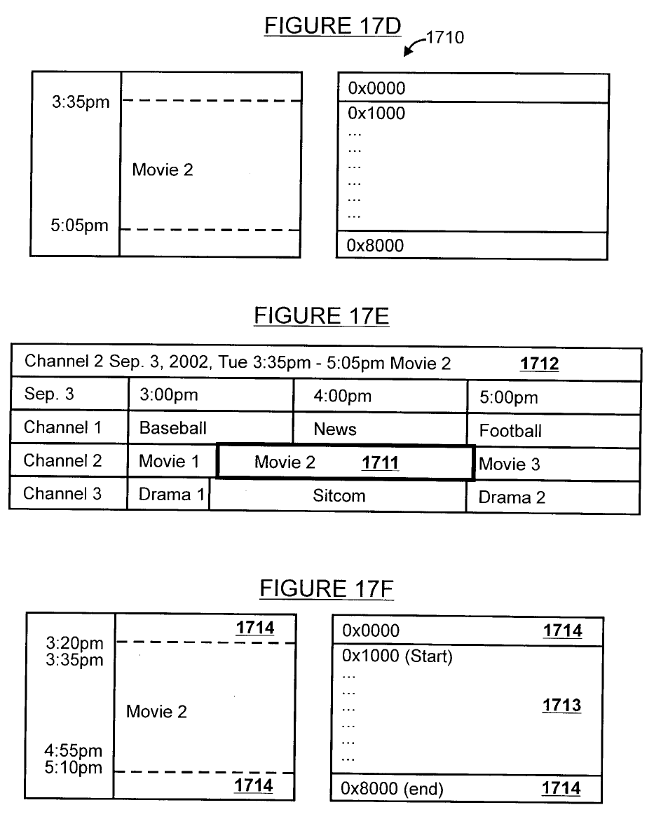

FIG. 17A illustrates showing a program list using EPG.

FIG. 17B illustrates showing a recording schedule list.

FIG. 17C illustrates showing a list of the recorded programs.

FIG. 17D illustrates showing a time offset table of recorded program.

FIG. 17E illustrates showing a program list using the updated EPG.

FIG. 17F illustrates showing a time offset table of recorded program using the updated EPG.

As discussed hereinabove, the Electronic Program Guide (EPG) provides a time schedule of the programs to be broadcast which can be utilized for scheduled recording in TV set-top box (STB) with digital video recording capability. However, the program schedule information provided by the EPG is sometimes inaccurate due to an unexpected change of programs to be broadcast. Thus, the start and end times of a program described in an EPG could be different from the time when the program is actually broadcast. In such instances, if the scheduled recording of a program were to be performed according to inaccurate EPG information, the start and end positions of the recorded program in the STB would not match to the actual positions of the program broadcast. In such a case, STB users would need to fast forward or rewind the recorded program in order to watch from the actual start time of the recorded program, which is inconvenient for users. Also, if a program starts late and is of a given duration, it will end late, and the ending of the program may be beyond the recording time allocated for the program.

According to an embodiment of the invention, generally, if an updated EPG with the accurate (e.g., actual) broadcast time schedule of programs is delivered, even after the recording started or finished, the updated EPG can be utilized such that users can easily watch the recorded program from the beginning.

The EPG is transmitted through broadcasting network 104 (FIG. 1A) directly from the broadcaster 102 or through modem or Internet from the EPG service provider 108 in order to provide the program schedule and information to the Set-top box (STB) users (“viewers”).

FIG. 16 (compare FIG. 1B) illustrates a STB for using updated EPG. It is similar to the STB 120 shown in FIG. 1B. The STB 1620 (compare 120) includes a HDD 1622 (compare 122), a tuner 1624 (compare 124), a demultiplexer (DEMUX) 1626 (compare 126), a decoder 1628 (compare 128) a CPU/RAM 1630 (compare 130), a user controller 1632 (compare 132), a display buffer 1642 (compare 142) and a display device 1634 (compare 134). The STB further comprises a modem 1640 for receiving EPG information via the Internet, a scheduler 1652, and a switch 1644. The switch 1644 is simply illustrative of being able to start and stop recording, under control of the scheduler 1652. On the reception of the EPG information, the STB can display the information of programs on the screen of the display device 1634. A user can then select a set of programs to be automatically recorded by using a remote control 1632. FIGS. 17A-17F are views of GUIs on the screen of the display device 1634.

FIG. 17A is a GUI of an EPG. For example, as illustrated by FIG. 17A, if a user wants to record the “Movie 2”, the user selects the area 1706 on the EPG screen of the display device 1634. The information on “Movie 2”, including the channel number, date, start time, end time and title, is displayed in an information window 1707 of the GUI.

In response to the user selecting (1632) a scheduled recording function, another GUI is displayed as shown in FIG. 17B (Recording Schedule List). Then, a scheduled recording button on the user controller is pressed and the recording scheduler 1652 sets the recording time as it is provided by the EPG.

However, as discussed above, the EPG time information of the corresponding program could be inaccurate due to reasons such as delayed broadcasting or an unexpected newsbreak. Thus, in order to reduce the possibility of missing the recording of the beginning and end parts of the broadcast program, the actual recording of the selected program is set to start at the time instant which is a predetermined time (such as ten minutes) before the EPG start time of the program, and the recording time is set to end at a predetermined time (such as ten minutes) after the EPG end time of the program. In this example, recording of the movie scheduled to be broadcast between 3:30 PM and 5:00 PM is set to occur from 3:20 pm to 5:10 pm.

As illustrated in FIG. 17B, the program to be recorded 1708 is added to the “Recording Schedule List”. Before starting the recording, the system checks the latest EPG information in order to confirm whether the broadcasting schedule is updated and, if so, the recording time is accordingly updated. In case of digital broadcasting, the EPG information is periodically delivered through an event information table (EIT) in the program and system information protocol (PSIP) for Advanced Television Systems Committee (ATSC), for example. Or, the EPG information can be delivered through the network connected to a STB. In case the EPG is transmitted through a modem installed in a STB (as in this example), the EPG is usually delivered only a few times a day, due to the need for making phone calls and connections, and the information in the EPG may not be current.

According to a feature of the invention, in order to receive the latest EPG information, it is economical and desirable to connect to the EPG service provider a predetermined time before the start and after the end of the recording times specified by the old EPG information. In any case, it will be safer to start the recording the predetermined time before the start time specified by the latest EPG information and end the recording a predetermined time after the end time, if any.

As illustrated in FIG. 17C, the recorded program 1709 is added into the “Recorded List”. The problem with this spare (excess) recording is that users need to fast forward the recorded program in order to find the start of the program. Thus, it will be advantageous if users are able to start playing from the actual start of the recorded program without manually fast forwarding the recorded video stream. Thus, if updated actual start and end times of the recorded program are available, the invention enables users to access the exact start and end positions for the program by transforming the actual broadcast times into the corresponding byte positions of the recorded video stream of the program based on program clock reference (PCR), presentation time stamp (PTS) or broadcast time delivered in case of digital broadcasting. Furthermore, if other information on the recorded program such as the temporal positions of commercial and news break are also available, our invention also enables users to directly access the positions of the recorded stream. In this case, since it takes time to compute a byte offset of the recorded stream corresponding to the broadcast time position for low-cost STB, an offset table 1710 (FIG. 17D) can be generated as soon as the recording is finished and such information is available for faster access to the stream. The table has a file position corresponding to each time code. For example, if the updated EPG 1711 (FIG. 17E), for example, updated start and end times corresponding to 3:35 pm and 5:05 pm, respectively, is transmitted to the system after recording and the information corresponding to the recorded program 1712 is changed, the system marks the updated start and end points, in the offset table 1713. After recording, when the recorded program is played back, the needless parts 1714 (FIG. 17F) are skipped for playing using the offset table.

IX. Automatic EPG Updating System Using Video Analysis

As discussed above, the problem with the scheduled recording based on inaccurate EPG is a possibility of missing the beginning or end parts of the program to be recorded. One of the possible existing solution is to start the recording of a program earlier than the start time from EPG and end the recording later than the end time from EPG, thus making the extra recording. In that case, due to the extra recorded program, a user may have to fast forward the video until the main program starts. If the updated EPG with accurate program starting time is provided (as described above), the problem will be clearly solved. However, it may be hard to generate updated EPG at the EPG service provider since they usually do not know the accurate starting time of the program.

According to the invention, a technique is provided for generating accurate updated EPG based on signal pattern matching approach. The system gathers the program start scenes, stores them to the database, extracts features from them, and then updates EPG by matching between features in database and those from live input signal. Thus, in this case, although the updated EPG is sent to DVRs after the program of interest already began, if a DVR starts the recording earlier than the start time described in the inaccurate EPG by predetermined amount of time, a user can directly jump to the start position of the program without fast forwarding it. The advantages of using the updated EPG is described in the previous section (VIII. Enhanced Video Playback using Updated EPG).

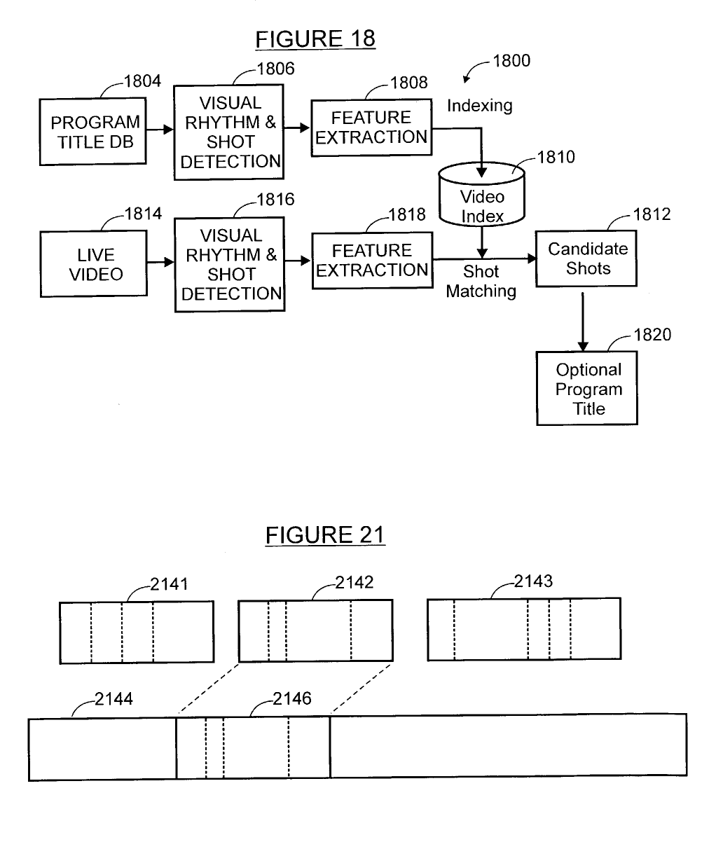

FIG. 18 is a block diagram illustrating an embodiment of a system 1800 for performing the pattern matching. The pattern matching system uses an abbreviated representation of the video, such as a visual rhythm (VR) image, to find critical points in a video. The major components are program title data base (DB) 1804, a functional block 1806 for extracting visual rhythm (VR) and performing shot detection on a stored video, a functional block 1808 for performing feature detection, and a video index 1810. A functional block 1816 is provided for extracting visual rhythm (VR) and performing shot detection on a live video (broadcast) 1814, and feature extraction 1818 (compare 1808) is performed. Candidate shots are identified in 1812, and titles may be added in 1820. The function of the system is discussed below.

As mentioned above, visual rhythm is a known technique whereby a video is sub-sampled, frame-by-frame, to produce a single image which contains (and conveys) information about the visual content of the video. It is useful, inter alia, for shot detection. A visual rhythm image is typically obtained by sampling pixels lying along a sampling path, such as a diagonal line traversing each frame. A line image is produced for the frame, and the resulting line images are stacked, one next to the other, typically from left-to-right. Each vertical slice of visual rhythm with a single pixel width is obtained from each frame by sampling a subset of pixels along a predefined path. In this manner, the visual rhythm image contains patterns or visual features that allow the viewer/operator to distinguish and classify many different types of video effects, (edits and otherwise), including: cuts, wipes, dissolves, fades, camera motions, object motions, flashlights, zooms, etc. The different video effects manifest themselves as different patterns on the visual rhythm image. Shot boundaries and transitions between shots can be detected by observing the visual rhythm image which is produced from a video.

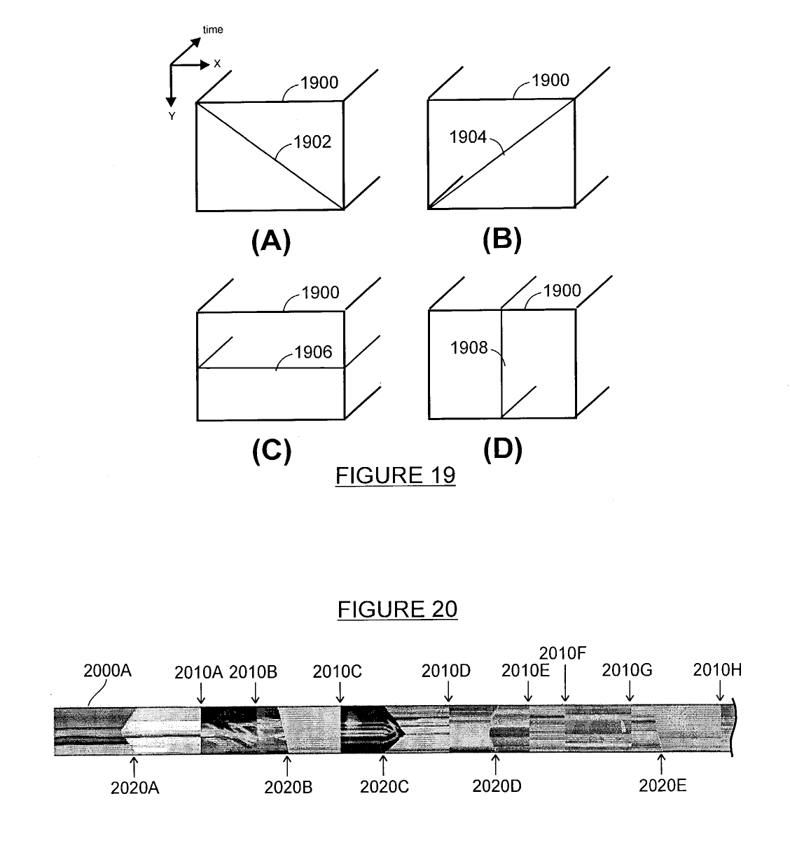

FIGS. 19(A-D) shows some examples of various sampling paths drawn over a video frame 1900. FIG. 19A shows a diagonal sampling path 1902, from top left to lower right, which is generally preferred for implementing the techniques of the present invention. It has been found to produce reasonably good indexing results, without much computing burden. However, for some videos, other sampling paths may produce better results. This would typically be determined empirically. Examples of such other sampling paths 1904 (bottom left to top right), 1906 (horizontal, across the image) and 1908 (vertical) are shown in FIGS. 19B-D, respectively. The sampling paths may be continuous (e.g., where all pixels along the paths are sampled), or they may be discrete/discontinuous where only some of the pixels along the paths are sampled, or a combination of both.

The diagonal pixel sampling (FIG. 19A) is said to provide better visual features for distinguishing various video edit effects than the horizontal FIG. 19C and the vertical pixel sampling FIG. 19D. And then, the video shots are extracted from the video title database by the shot detector using the VR. Afterward, the feature vectors are generated from the video shots. The feature vectors are indexed and stored into video index. After the construction of video index, the live broadcast video is input and its feature vectors are extracted by the same method of the construction of video index. The matching between the feature vectors of the live broadcast video and of the stored video enables the program start position to be automatically found.

FIG. 20 is a diagram showing a portion 2000A of a visual rhythm image. Each vertical line in the visual rhythm image is generated from a frame of the video, as described above. As the video is sampled, the image is constructed, line-by-line, from left to right. Distinctive patterns in the visual rhythm indicate certain specific types of video effects. In FIG. 20, straight vertical line discontinuities 2010A, 2010B, 2010C, 2010D, 2010E, 2010F, 2010G and 2010H in the visual rhythm portion 2000A indicate “cuts”, where a sudden change occurs between two scenes (e.g., a change of camera perspective). Wedge-shaped discontinuities 2020A, 2020C and 2020D, and diagonal line discontinuities 2020B and 2020E indicate various types of “wipes” (e.g., a change of scene where the change is swept across the screen in any of a variety of directions).

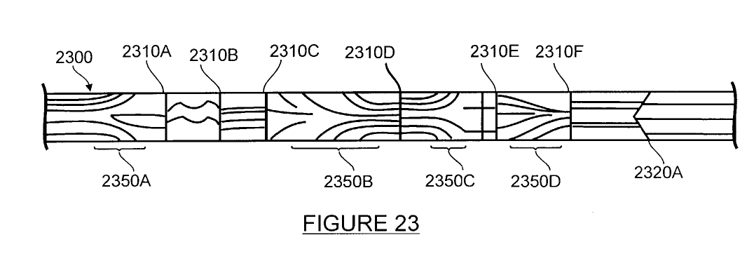

FIG. 23 is a diagram showing a portion 2300 of a visual rhythm image. Each vertical line (slice) in the visual rhythm image is generated from a frame of the video, as described above. As the video is sampled, the image is constructed, line-by-line, from left to right. Distinctive patterns in the the visual rhythm image indicate certain specific types of video effects. In FIG. 23, straight vertical line discontinuities 2310A, 2310B, 2310C, 2310D, 2310E, 2310F, indicate “cuts” where a sudden change occurs between two scenes (e.g., a change of camera perspective). Wedge-shaped discontinuities 2320A and diagonal line discontinuities (not shown) indicate various types of “wipes” (e.g., a change of scene where the change is swept across the screen in any of a variety of directions). Other types of effects that are readily detected from a visual rhythm image are “fades” which are discernable as gradual transitions to and from a solid color, “dissolves” which are discernable as gradual transitions from one vertical pattern to another, “zoom in” which manifests itself as an outward sweeping pattern (two given image points in a vertical slice becoming farther apart) 2350A and 2350C, and “zoom out” which manifests itself as an inward sweeping pattern (two given image points in a vertical slice becoming closer together) 2350B and 2350D.

FIG. 21 illustrates an embodiment of the invention showing the result of matching between the live broadcast video shots and the stored video shots. The database consists of program#1 2141, program#2 2142, program#3 2143, and so forth. Each shot of the live broadcast video 2144 is compared with all shots of the programs in the database 1804 by using a suitable image pattern matching technique, and the part of the live broadcast video 2146 (1814) is matched to 2142. The system indicates that the program#2 started, obtains the start time, and updates the EPG.

X. Efficient Method for Displaying Images or Video in a Display Device

The invention includes an efficient technique for displaying reduced-size images or reduced-size video stream in a display device with restricted size, for example consumer devices such as DVR or personal digital assistant (PDA). Although the size of the display devices are getting larger with the advances being made in technology, their display sizes are “restricted” in the sense that various applications require that multiple images be displayed concurrently, or the size of the image to be displayed is restricted due to user interface issues. Therefore, images are typically reduced in size for display.

For example, the aforementioned U.S. Pat. No. 6,222,532 (“Ceccarelli”) describes a method for navigating through video matter by displaying multiple key frame images. However, in most of the cases, the displayed images may be too small for users to recognize them, because content displayed through consumer devices such as STB are typically viewed from a far distance (e.g., greater than 1 meter).

For example, when multiple reduced-size images (e.g., 501) are needed to be displayed in a display device (e.g., 134, 420) for a DVR or PDA application, the resolution of the individual reduced-size images to be displayed would be restricted to a certain size, based on the resolution of the display and the fact that multiple reduced-size images are being displayed, each occupying only a small portion of (or window within) the overall display. This is apparent from the display(s) of reduced-size images set forth hereinabove, including, for example, those shown in FIGS. 2A (204), 2B (204), 2C (204), 5A (501A . . . L), 5B (501A . . . L), 6 (604), 9 (904), 10 (1001A . . . L), 14A (1421A . . . C), and 14B (1422A . . . G).

According to the invention, an efficient way of displaying reduced-size images or a reduced-size video stream is provided such that the images (or video stream) are more easily recognizable, given a comparable (e.g., same) display area as is available using conventional methods.

One of the applications of reduced-size images is video indexing, whereby a plurality of reduced-size images are presented to a user, each on representing a miniature “snapshot” of a particular scene in a video stream. Once the digital video is indexed, more manageable and efficient forms of retrieval may be developed based on the index that facilitate storage and retrieval.

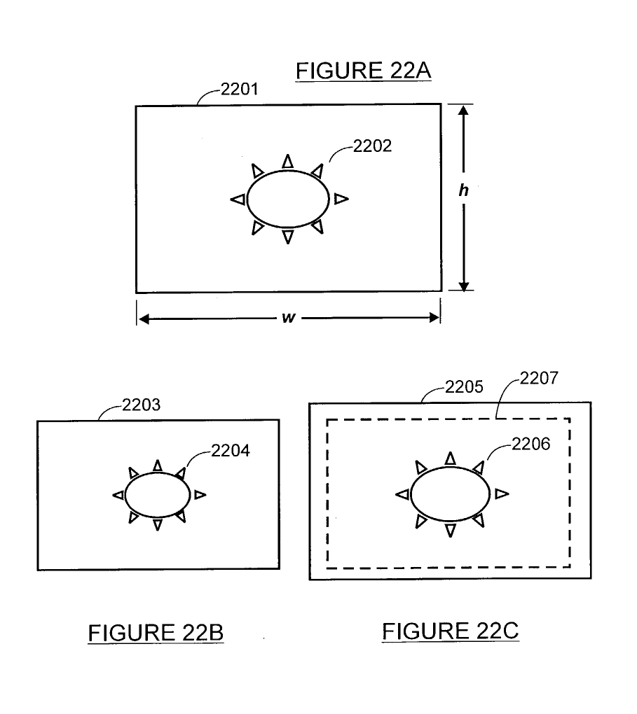

FIG. 22A shows an original-size image 2201. The overall image 2201 has a width “w” and a height “h”, and is typically displayed in a rectangular window. The window can be considered to be the overall image. The image 2201 contains a feature of interest 2202, shown as a starburst. Typically, the feature of interest could be a face.

Conventional methods for reducing image size reduce the entire original image 2201 to an arbitrary resolution that is allowed for an individual key frame image for display on the display device. An example of a reduced image is shown in FIG. 22B. Here it is seen that the resulting overall image 2203 is smaller (by a given percentage, e.g., 67%), and that the feature of interest 2204 is commensurately smaller (by the same given percentage). Everything is scaled, uniformly, proportionately. However, reducing the original image by the conventional method is not optimal, since it is very hard to see and recognize the reduced key frame image as a whole. Particularly, for example, with regard to recognizing the reduced-size feature of interest.

FIG. 22C illustrates an efficient method to reduce and display an image in a restricted display area. First, the original image 2201 is reduced by a specified percentage which results in a reduced-size image 2205 that is somewhat larger than the allowed resolution in an adaptive window 2207 (dashed line). Then, the reduced-size image 2205 is cropped according to the size of the adaptive window 2207 utilized for locating the region to be cropped in the reduced image 2205. Alternatively, the original image can first be cropped, then reduced in size.

The adaptive window 2207 is preferably located at the center of the reduced-size image 2205 because the feature of interest 2206 is typically at the center of the image. The resolution of the adaptive window 2207 is identical to the allowed resolution 2203 for each individual reduced image for display. Therefore, the final reduced image displayed on the display device is the image within the adaptive window 2207. For example, the original image 2201 is reduced to 67% of its original size (height and width) using the conventional method as in FIG. 22B resulting in the image 2203. Using the inventive technique, the original image 2201 is reduced to 75% of its original size, then cropped (or vice-versa) to fit within an adaptive window 2207 which is 67% the size of the original image 2201. The reduced-size feature of interest 2206 is thus larger (75%) in FIG. 2(c) than the reduced-size feature of interest 2204 in FIG. 22B, and will therefore be better recognizable.

Although the reduced-size image 2207 is cropped at the center due to empirical observation that important objects mostly reside at the center, the cropped area can be adaptively tracked according to the content to be displayed. For example, one can assume that this default window size 2203 is to contain the central 64% area by eliminating 10% background from each of the four edges. The default window location however can be varied or updated after scene analysis such as face/text detection. The scene analysis can thus be utilized to automatically track adaptive window utilized for locating the region to be cropped such that faces or text could be included according to user preference. Also the same approach could be used for displaying the video stream in reduced-size.

Alternatively, only the appropriate part of the image is partially decoded to reduce computation rather than reducing the image and then cropping.

This technique is related to the subject matter discussed with respect to FIGS. 45 and 46 of the aforementioned U.S. patent application Ser. No. 09/911,293. For example, as described therein,

FIG. 46 illustrates an example of focus of attention area 4604 within the video frame 4602 that is defined by an adaptive rectangular window in the figure. The adaptive window is represented by the position and size as well as by the spatial resolution (width and height in pixels). Given an input video, a simplified transcoding process can be summarized as:

1. Perform a scene analysis within the entire frame or certain slices of the frame;

2. Determine the widow size and position and adjust accordingly; and

3. Transcode the video according to the determined window.

Given the display size of the client device, the scene (or content) analysis adaptively determines the window position as well as the spatial resolution for each frame/clip of the video. The information on the gradient of the edges in the image can be used to intelligently determine the minimum allowable spatial resolution given the window position and size. The video is then fast transcoded by performing the cropping and scaling operations in the compressed domain such as DCT in case of MPEG-1/2.

The present invention also enables the author or publisher to dictate the default window size. That size represents the maximum spatial resolution of area that users can perceptually recognize according to the author's expectation. Furthermore, the default window position is defined as the central point of the frame. For example, one can assume that this default window size is to contain the central 64% area by eliminating 10% background from each of the four edges, assuming no resolution reduction. The default window can be varied or updated after the scene analysis. The content/scene analyzer module analyzes the video frames to adaptively track the attention area. The following are heuristic examples of how to identify the attention area. These examples include frame scene types (e.g., background), synthetic graphics, complex, etc., that can help to adjust the window position and size.

4.2.1 Landscape or Background

Computers have difficulty finding outstanding objects perceptually. But certain types of objects can be identified by text and face detection or object segmentation. Where the objects are defined as spatial region(s) within a frame, they may correspond to regions that depict different semantic objects such as cards, bridges, faces, embedded texts, and so forth. For example, in the case that there exist no larger objects (especially faces and text) than a specific threshold value within the frame, one can define this specific frame as the landscape or background. One may also use the default window size and position.

4.2.2 Synthetic graphics

One may also adjust the window to display the whole text. The text detection algorithm can determine the window size.

4.2.3 Complex

In the case of the existing recognized (synthetic or natural) objects whose size is larger than a specific threshold value within the frame, initially one may select the most important object among objects and include this object in the window. The factors that have been found to influence the visual attention include the contrast, shape, size and location of the objects. For example, the importance of an object can be measured as follows:

1. Important objects are in general in high contrast with their background;

2. The bigger the size of an object is, the more important it is;

3. A thin object has high shape importance while a rounder object will have lower one; and

4. The importance of an object is inversely proportional to the distance of center of the object to the center of the frame.

At a highly semantic level, the criteria for adjusting the window are, for example:

1. Frame with text at the bottom such as in news; and

2. Frame/scene where two people are talking each other. For example, person A is in the left side of the frame. The other is in the right side of the frame. Given the size of the adaptive window, one cannot include both in the given window size unless the resolution is reduced further. In this case, one has to include only one person.

The invention has been illustrated and described in a manner that should be considered as exemplary rather than restrictive in character—it being understood that only preferred embodiments have been shown and described, and that all changes and modifications that come within the spirit of the invention are desired to be protected. Undoubtedly, many other “variations” on the techniques set forth hereinabove will occur to one having ordinary skill in the art to which the present invention most nearly pertains, and such variations are intended to be within the scope of the invention, as disclosed herein. A number of examples of such “variations” have been set forth hereinabove.

What is claimed is:

1. Method of accessing video programs that have been recorded, comprising:
displaying a list of the recorded video programs;
locally generating content characteristics for a plurality of video programs which have been recorded; and
displaying the content characteristics of the plurality of video programs, thereby enabling users to easily select the video of interest as well as a segment of interest within the selected video.

2. Method, according to claim 1, further comprising:
for each of a plurality of recorded video programs, displaying information including at least one of the title, recording time, duration and channel of the video program.

3. Method, according to claim 1, wherein:
generating the content characteristic according to user preference.

4. Method, according to claim 3, further comprising:
obtaining the user preference from a video bookmark history.

5. Method, according to claim 1, wherein;
the content characteristic comprises at least one key frame image.

6. Method, according to claim 1, wherein;
the content characteristic comprises a plurality of images displayed in the form of an animated image or a video stream shown in a small size.

7. Method, according to claim 6, wherein:
the video stream can be fast rewound or forwarded.

8. Method, according to claim 1, further comprising:
displaying, for each of a plurality of stored video programs, a text field and an image field; and
scrolling through the fields to select a video program of interest.

9. Method, according to claim 8, wherein:
the text field comprises at least one of title, recording time, duration and channel of the video; and
the image field comprises at least one of still image, a plurality of images displayed in the form of an animated image or a video stream shown in a small size.

10. Method, according to claim 8, further comprising:
displaying an animated image or video stream for the selected video program.

11. Method, according to claim 8, wherein;
the image field comprises a video stream of the video program shown in a small size.

12. Method, according to claim 8, further comprising:
displaying a preview of the selected video program.

13. Method, according to claim 8, further comprising:
displaying a live broadcast.

14. Method, according to claim 1, wherein:
the content characteristics comprise reduced-sized images/frames.

15. Method, according to claim 14, further comprising:
generating the reduced-sized images/frames by partially decoding rather than fully decoding video frames, using either a partial decoder chip or a CPU.

16. Method, according to claim 14, wherein the reduced-sized images are generated based on the bookmarked relative time or byte position of a desired reduced-sized image from the beginning of the multimedia content.

17. Method, according to claim 1, wherein the content characteristic comprises a reduced-size image corresponding to a larger, original image, and further comprising displaying the reduced-size image by:
reducing the original image to a size which is larger than the size of a display area; and
cropping the reduced-size image to fit within the display area.

18. Method, according to claim 1, wherein the content characteristic comprises a reduced-size image corresponding to a larger, original image, and further comprising displaying the reduced-size image by:
partially decoding an appropriate part of an image, and
reducing the resulting image size.

19. Method of browsing video programs in broadcast streams comprising:
browsing channels;
generating content characteristics from the associated broadcast streams; and
displaying the content characteristics.

20. Method, according to claim 19, wherein:
the content characteristic comprise temporally sampled reduced-size images from the associated broadcast streams.

21. Method, according to claim 20, further comprising:
generating the reduced-sized images by partially decoding rather than fully decoding video frames, using either a partial decoder chip or a CPU.

22. Method, according to claim 19, further comprising:
selecting a first broadcast stream and displaying the broadcast stream along with displaying the content characteristics.

23. Method, according to claim 19, further comprising:
with a first tuner, selecting the first broadcast stream, and
with a second tuner, browsing other channels.

24. Method, according to claim 19, further comprising:
browsing frequently-tuned channels based on information about a user's channel preferences.

25. Method, according to claim 24, further comprising:
collecting information about which channels the user watches, when and for how long they are watched; and
controlling channel browsing based on the collected information.

26. Method, according to claim 19, further comprising:
displaying favorite channels or services based on user's viewing preferences.

27. Method, according to claim 19, further comprising:
displaying information from an electronic program guide (EPG).

28. Method, according to claim 19, wherein the content characteristic comprises a reduced-size image corresponding to a larger, original image, and further comprising displaying the reduced-size image by:
reducing the original image to a size which is larger than the size of a display area; and
cropping the reduced-size image to fit within the display area.

29. Method, according to claim 19, wherein the content characteristic comprises a reduced-size image corresponding to a larger, original image, and further comprising displaying the reduced-size image by:
partially decoding an appropriate part of an image, and
reducing the resulting image size.

30. Method of displaying an electronic program guide (EPG), comprising:
prioritizing a user's favorite channels; and
displaying the user's favorite channels in the order of preference in the EPG.

31. Method, according to claim 30, wherein:
a list of favorite channels is specified by the user.

32. Method, according to claim 30, wherein:
a list of favorite channels is determined automatically by analyzing user history data and tracking the user's channels of interest.

33. Method, according to claim 32, further comprising:
collecting information about which channels the user watches, when and for how long they are watched; and
and automatically determining the user's channels of interest based on the collected information.

34. Method of scheduled recording based on an electronic program guide (EPG), comprising:
storing an EPG;
selecting a program for recording;
scheduling recording of the program based on information in the EPG to start a predetermined time before the scheduled start time and to end a predetermined time after the scheduled end time.
further comprising:
checking for updated EPG information of actual broadcast times a predetermined time before and a predetermined time after recording the program, and accessing the exact start and end positions for the recorded program based on the actual broadcast times; and
gathering program start scenes and storing them in a database, extracting features from them, and then updating the EPG by matching between features in the database and those from the live input signal.
